(19) United States
(12) Patent Application Publication
(10) Pub. No.: US 2025/0176590 A1
(43) Pub. Date: Jun. 5, 2025

(54) PROTEIN-BASED MEAT ANALOGS AND METHODS OF MANUFACTURE THEREOF

(71) Applicant: CHUNK FOODS INC., New York, NY (US)

(72) Inventor: Amos GOLAN, Tel Aviv (IL)

(21) Appl. No.: 19/051,550

(22) Filed: Feb. 12, 2025

Related U.S. Application Data
(63) Continuation of application No. PCT/IB2023/058187, filed on Aug. 14, 2023.
(60) Provisional application No. 63/397,879, filed on Aug. 14, 2022.

(51) Int. Cl. A23J 3/22; A23J 1/00; A23J 3/14

(52) U.S. Cl. CPC A23J 3/227; A23J 1/006; A23J 3/14

(57) ABSTRACT

Fermented meat analogs and methods of producing such meat analogs, the meat analogs comprising protein-containing strands, and a mycelium of a fermenting microorganism, wherein the protein-containing strands are held together or bound together by the mycelium to form the fermented meat analog.

### RELATED APPLICATION

This application is a continuation of PCT/IB2023/058187, filed on Aug. 14, 2023, which is incorporated herein by reference in its entirety.

### FIELD OF THE INVENTION

The present invention relates in general to food items and methods of manufacture thereof, and more particularly, to fermented protein-based meat analogs and methods of manufacture thereof.

### SUMMARY OF THE INVENTION

In accordance with aspects of the present invention, there is provided a method of manufacturing a fermented protein-based food item, the method comprising:
a. obtaining protein strands of a protein-based substance containing at least 25% protein, by weight, on a dry basis, wherein said strands have a dimensionless aspect ratio ASP defined by:

$$ASP = {L}^{2} / Ax$$

wherein:
   L is the average length of the long dimension said strands; and
   Ax is the average cross-sectional area of the strand dimensions transverse to said long dimension;
and wherein ASP is at least 100;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

In accordance with aspects of the present invention, there is provided a fermented protein-based meat analog, comprising:
protein strands having a dimensionless aspect ratio ASP defined by:

$$ASP = {L}^{2} / Ax$$

wherein:
L is the average length of the long dimension said strands; and
Ax is the average cross-sectional area of the strand dimensions transverse to said long dimension;
   and wherein ASP is at least 35; and
a mycelium of a fermenting microorganism;
   wherein the protein strands are held together or bound together by the mycelium to form the fermented meat analog.

In accordance with further aspects of the present invention, there is provided a fermented meat analog, comprising protein-containing strands, and a mycelium of a fermenting microorganism, wherein the protein-containing strands are held together or bound together by the mycelium to form the fermented meat analog.

Further aspects and features of the invention are provided hereinbelow.

### BRIEF DESCRIPTION OF THE FIGURES

The foregoing discussion will be understood more readily from the following detailed description of the invention, when taken in conjunction with the accompanying FIGS. 1 to 13B), in which:

FIG. 1 is a is a flow chart of a method of manufacturing a fermented protein-based meat analog according to embodiments of the disclosed technology;

FIG. 2 is a schematic illustration of a step of obtaining strands forming part of the method of FIG. 1 according to embodiments of the disclosed technology;

FIGS. 3A, 3B, 3C, and 3D are schematic illustrations of various implementations of an inoculating step forming part of the method of FIG. 1, according to embodiments of the disclosed technology;

FIG. 4 is a schematic illustration of a bundling step forming part of the method of FIG. 1, according to embodiments of the disclosed technology;

FIGS. 5A, 5B, and 5C are schematic illustrations of various implementations of an enveloping step forming part of the method of FIG. 1, according to embodiments of the disclosed technology;

FIG. 6 is a schematic illustration of a fermentation step forming part of the method of FIG. 1, according to embodiments of the disclosed technology;

FIG. 7 is a schematic illustration of a microorganism deactivation step forming part of the method of FIG. 1, according to embodiments of the disclosed technology;

FIG. 8 is a schematic illustration of a liquid addition step forming part of the method of FIG. 1, according to embodiments of the disclosed technology;

FIGS. 9A, 9B, 9C, and 9D are schematic illustrations of various implementations of a cutting step forming part of the method of FIG. 1, according to embodiments of the disclosed technology;

FIG. 10 is a schematic illustration of a point of fracturing of a fermented protein-based meat analog according to the disclosed technology, when force is applied thereto;

FIGS. 11A, 11B, and 11C are microscopy images of a fermented structure formed during manufacture of a fermented protein-based meat analog according to the disclosed technology;

FIGS. 12 is a microscopy image of a fermented structure formed during manufacture of a fermented protein-based meat analog according to the disclosed technology;

FIGS. 13A and 13B are microscopy images of a fermented protein-based meat analog according to the disclosed technology;

FIG. 14A is a flowchart of a method of determining the void fraction of a sample according to the disclosed technology; and

FIGS. 14B, 14C, and 14D are images of steps of the method of FIG. 14A.

### DESCRIPTION OF THE PREFERRED EMBODIMENTS

The principles of the inventive fermented protein-based meat analog and for the method of manufacture thereof, may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

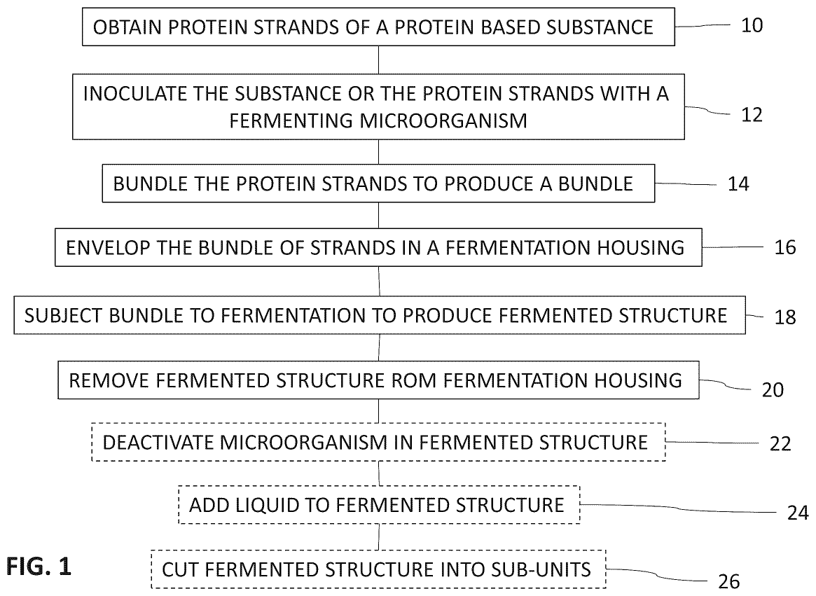

Reference is made to FIG. 1, which is a flow chart of a method of manufacturing a fermented protein-based meat analog according to embodiments of the disclosed technology.

As seen at step 10, protein strands are obtained. The protein strands are formed of a protein-based substance.

As used herein in the specification and in the claims section that follows, the term “protein-based” with respect to a component, material, etc. (e.g., “protein-based substance”), refers to a content of at least 20% protein, by weight, on a dry basis.

Similarly, the term “protein strand” refers to a strand containing at least 20% protein, by weight, on a dry basis.

In some embodiments, the protein-based substance contains at least 25% protein, by weight, on a dry basis.

In some embodiments, the protein-based substance contains at least 30%, at least 35%, at least 40%, at least 45%, or at least 50% protein by weight on a dry basis.

In some embodiments, the protein of the protein-based substance includes plant protein. In some embodiments, protein of the protein-based substance predominantly includes, or consists essentially of, plant protein.

In some embodiments, the protein of the protein-based substance includes soy protein, pea protein, lentil protein, bean protein, chickpea protein, fungal protein, fava protein, or wheat protein.

In some embodiments, the protein of the protein-based substance includes gluten.

In some embodiments, the protein of the protein-based substance includes extruded vegetable protein, which may be low-moisture extruded vegetable protein or high-moisture extruded vegetable protein.

In some embodiments, the protein of the protein-based substance includes denatured protein. In some embodiments, the protein of the protein-based substance predominantly includes, or consists essentially of, denatured protein.

In some embodiments, the protein of the protein-based substance includes cross-linked protein. In some embodiments, protein of the protein-based substance predominantly includes, or consists essentially of, cross-linked protein.

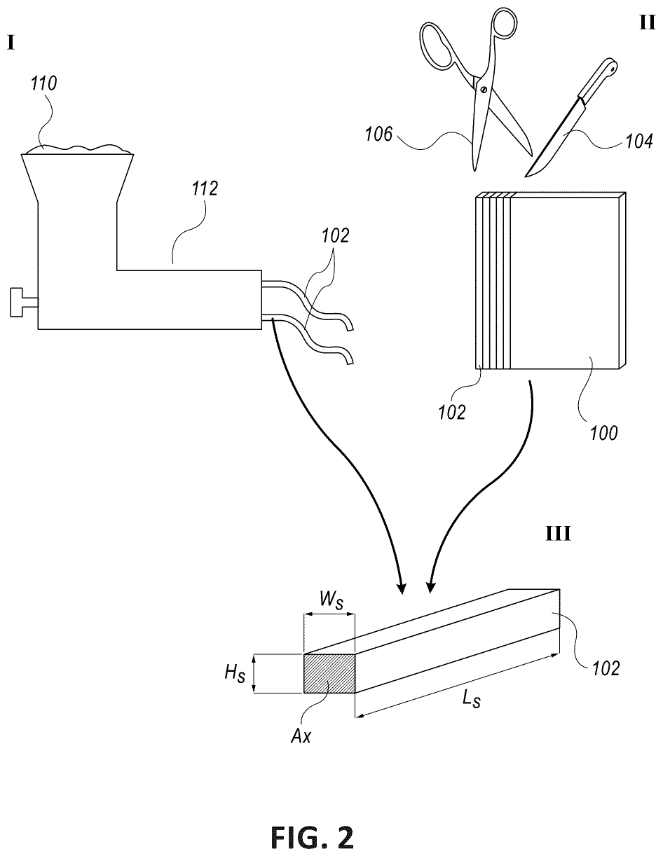

FIG. 2 illustrates various methodologies for obtaining the protein strands.

In other embodiments, illustrated at area I of FIG. 2, a mixture 110 of the protein-based substance is placed in an extruder 112, and protein strands 102 are extruded therefrom, as known in the art of food extrusion.

In some embodiments, illustrated at area II of FIG. 2, a piece 100 of the protein-based substance is cut into protein strands 102, for example using a knife 104, scissors 106, a suitable die, or any suitable cutting mechanism. For example, piece 100 of the protein-based substance may be an extruded piece of the substance.

The resulting protein strands 102 have a long dimension, indicated by Lₛ, a width dimension, indicated by Wₛ, and a height dimension, indicated by Hₛ, in area III of FIG. 2. An average cross-sectional area of protein strands 102, in a direction transverse to the long dimension or to a longitudinal axis of the strand is labeled by Ax and is indicated by hatching in area III of FIG. 2.

In some embodiments, a maximal dimension Dₘₐₓ of the height (Hs) and width (Wₛ) of strands 102 is in the range of 0.5 mm to 5 mm. This is the maximal dimension in the cross-section of the longitudinal axis of the strands 102.

In some embodiments, maximal dimension Dₘₐₓ is in the range of 0.5 to 4 mm, 0.5 mm to 3 mm, 0.5 mm to 2 mm, or 1 mm to 2 mm.

Strands 102 have a dimensionless aspect ratio ASP defined by ASP=L²/Ax, where L is an average length of the long dimension L of strands 102.

In some embodiments, ASP is at least 100, at least 250, at least 500, at least 750, at least 1,000, at least 10,000, at least 50,000, or at least 100,000.

In some embodiments, Ax is within a range of 0.25 mm² to 25 mm² or within a range of 1 mm² to 25 mm².

In some embodiments, the average length L of the long dimension Ls of strands 102 is at least 1 mm, least 3 mm, least 4 mm, at least 5 mm, at least 8 mm, at least 10 mm, at least 15 mm, at least 20 mm, at least 50 mm, at least 100 mm, at least 250 mm, or at least 500 mm. In some embodiments, L is in the range of 5 mm to 600 mm.

Returning to FIG. 1, at step 12, the protein-based substance, whether as piece 100 or as mixture 110 (FIG. 2), or the strands 102 are inoculated with an inoculum including a fermenting microorganism.

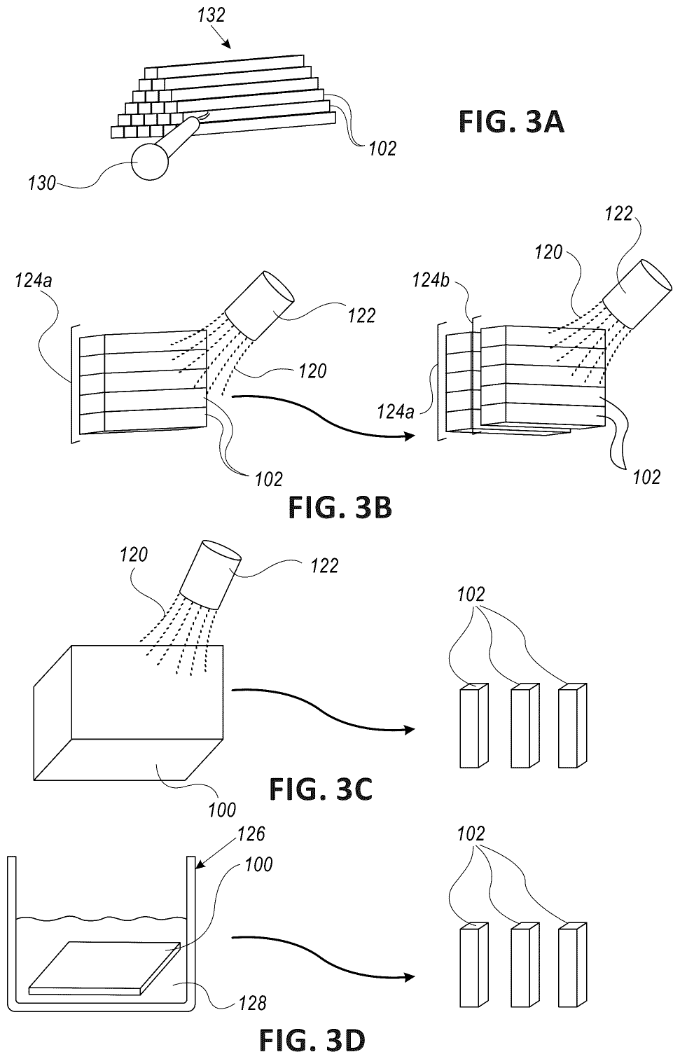

Reference is now additionally made to FIGS. 3A, 3B, 3C, and 3D, which are schematic illustrations of various implementations of inoculating step 12.

In some embodiments, the inoculum may be blown from a blower 130 onto protein-based substance 100 or 110, onto strands 102, or onto and/or into a bundle 140 of strands 102, as illustrated in FIG. 3A. Similarly, a liquid suspension of the inoculum may be sprayed onto and/or into the bundle. In some such embodiments, inoculation step 12 may occur following a bundling step, described hereinbelow.

In some embodiments, the protein strands are inoculated, as shown in FIG. 3B. In some embodiments, the inoculation of the protein strands may be in a layer-by-layer manner. For example, inoculum 120 may be sprinkled from a container 122 onto a layer 124a of protein strands 102. A subsequent layer 124b of protein strands is placed above the inoculated strands of layer 124a, and additional inoculum 120 is sprinkled thereon from container 122. The process may be repeated for as many layers as desired. For example, the process may be repeated for 10 to 200 layers. In some embodiments, the inoculum is sprinkled only on a single side, or face, of each of strands 102, and the layering of the strands ensures that, for most of the strands, the inoculum impacts at least two sides, or faces, of the strands.

The inoculum may be sprinkled onto strands 102 in a less organized, not layer-by-layer, manner. However, as explained in detail hereinbelow, because the directional orientation of the longitudinal axes of strands 102 is significant, the inoculation is be carried out without fully mixing the strands, which would typically result in changes to their directional orientations.

In some embodiments, inoculum 120 may be scattered onto piece 100 of the protein-based substance prior to cutting thereof into strands 102, as shown in FIG. 3C. In such embodiments, step 12 of FIG. 1 would occur prior to step 10.

Similarly, in some embodiments, the inoculum may be scattered onto or mixed into mixture 110 of the protein-based substance prior to extrusion of strands 102.

It will be appreciated that although FIGS. 3B and 3C illustrate a powder-phase inoculum being sprinkled, or scattered, onto the strands or the protein-based substance, a powder-phase inoculum may be blown onto the strands or the protein-based substance, or a liquid-phase suspension including the inoculum may be sprayed onto the strands or the protein-based substance.

In some embodiments, strands 102 of the protein-based substance may be dipped into a receptacle 126 having disposed therein a liquid suspension 128 including the inoculum, as illustrated in FIG. 3D. In some embodiments, in which the protein based substance is dipped into liquid suspension 128, strands 102 may be cut or extruded following the inoculation. In some embodiments, in which strands 102 are dipped into liquid suspension 128, the strands may be dipped in a layer-by-layer manner as described hereinabove with respect to FIG. 3B.

In some embodiments, following inoculating step 12, the inoculum covers a surface area of protein strands 102 in the range of 5% to 95%, 10% to 95%, 15% to 95%, 15% to 90%, 15% to 85%, 15% to 80%, 20% to 80%, or 30% to 80%.

The inventors have found that that the coverage of the strands by the inoculum must be sufficient to ensure effective fermentation, as described hereinbelow. However, the inventors have found that using high coverage ratios may actually be deleterious to the fermentation process, particularly at high concentrations of the fermenting microorganism within the inoculum.

In some embodiments, in addition to the fermenting microorganism, the inoculum further includes at least one dilution agent. In some embodiments, in which the inoculum is in a powder phase, the dilution agent(s) may include soy flour, pea flour, defatted soy flour, wheat flour, corn starch, tapioca starch, potato starch, silica, sugar, salt, maltodextrin, fibers, gluten, rice flour, potato starch, and the like.

In some embodiments, in which the inoculum is in a liquid phase, the dilution agent(s) may include a liquid, such as water, a liquid edible oil or emulsion thereof, alcohol (ethanol etc.), or glycerin, with or without surfactants.

In some embodiments, the fermenting microorganism comprises at least 0.1%, at least 0.5%, at least 1%, at least 1.5%, at least 2%, at least 3%, at least 5% or at least 10% of the inoculum.

In some embodiments, a weight of the fermenting microorganism in the inoculum is in the range of 0.1-10%, in the range of 0.2-10%, or in the range of 0.5-10%, by weight, of the protein strands.

In some embodiments, the fermenting organism is a binding structure forming organism. In some embodiments, the binding structure forming organism is a mycelium forming organism, and the binding structure is mycelium.

For the purpose of the present application, a mycelium forming organism is an organism that forms interwoven filamentous hyphae. For example, the mycelium forming microorganism may be a mycelium forming fungus, such as Aspergillus Oryzae or Sojae, Rhizopus Oligosporus, Rhizopus Oryzae, edible Neurospora strains such as Neurospora Cressa, edible gourmet mushrooms, for example Agaricus bisporus, Schizophyllum commune, Ganoderma lucidum, or Pleurotus ostreatus.

As another example, the fermenting microorganism may be a polysaccharide forming bacteria, such as bacillus subtilis.

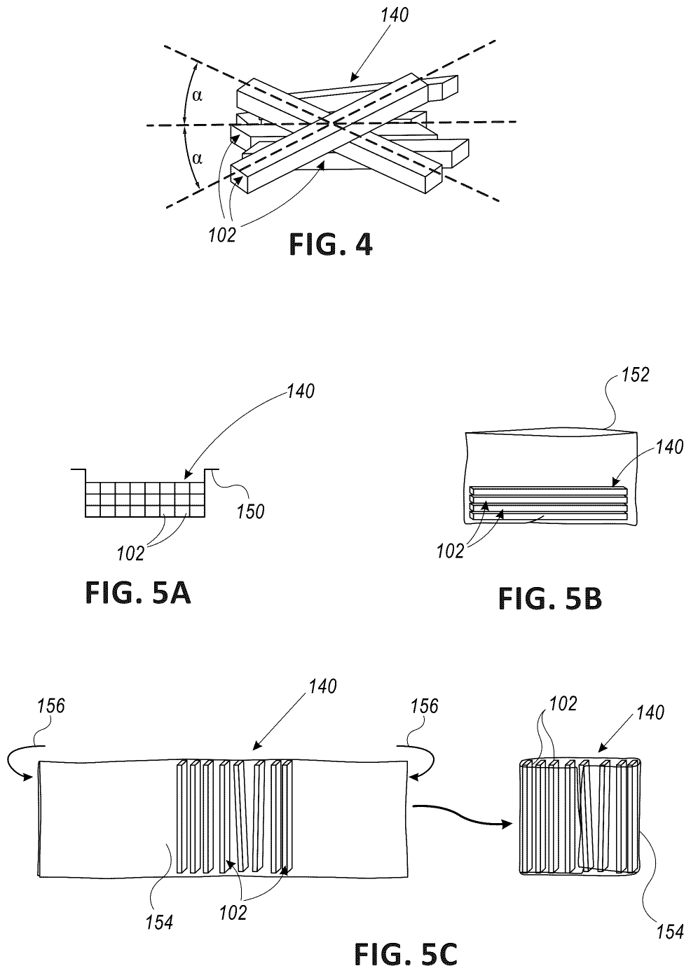

Returning to FIG. 1, at step 14, protein strands 102 are bundled, to produce a bundle of strands 140. Bundle 140 is shown in FIGS. 3A and 4. Bundling of the protein strands may be carried out in any suitable way, such as manually gathering the strands into a bundle, picking up a base surface on which the strands are placed to form the bundle, using a machine to gather the strands into a bundle.

Within the context of the present specification and the claims that follow, the term “bundling” is defined as forming of a pile or stack of items, such as strands, but does not necessitate tying or binding the items together. Similarly, a “bundle” need not be tied together, and may include loosely stacked or piled items.

In some embodiments, bundling step 14 may occur following inoculating step 12. In other embodiments, bundling step 14 may occur prior to inoculating step 12. In such embodiments, the inoculation of the protein strands 102 is carried out within bundle 140, for example as shown in FIG. 3A.

Typically, during bundling of protein strands 102 to form bundle 140, a directional orientation of the longitudinal axes of at least 80% of the protein strands 102 is maintained. In some embodiments, the directional orientation of at least 85%, at least 90%, or at least 95% of the strands is maintained. Maintaining of the directional orientation of the strands during the bundling assists in the resulting fermented protein-based meat analog having a directionality to its fibers such that it may structurally resemble animal-based foods, such as meat or fish.

In some embodiments, within bundle 140, longitudinal axes of at least 80% of protein strands 102 are within α degrees of the longitudinal axis of the bundle.

In some embodiments, within bundle 140, longitudinal axes of at least 80% of protein strands 102 are within α degrees with respect to the direction of a reference strand. As such, the longitudinal axes of the at least 80% of the strands may be within an angle of +α degrees from the reference strand or −α degrees from the reference strand.

In some embodiments, longitudinal axes of at least 85%, at least 90%, or at least 95% of protein strands 102 are within α degrees of the longitudinal axis of the bundle.

In some embodiments, longitudinal axes of at least 85%, at least 90%, or at least 95% of protein strands 102 are within α degrees with respect to the direction of a reference strand.

In some embodiments, α is 30 degrees, 25 degrees, 20 degrees, 15 degrees, 10 degrees, 5 degrees.

In some embodiments, in which the strands 102 are inoculated prior to bundling thereof, bundling of protein strands 102 may cause the inoculum to spread over a greater surface area of the protein strands than that achieved during the inoculating step.

Following the inoculating at step 12 and the bundling at step 14, bundle 140 is enveloped in a fermentation housing at step 16.

In the context of the present specification and claims, a fermentation housing is any container that can contain bundle 140 of protein strands 102 during fermentation. As such, the fermentation housing must be inert to protein strands 102, to the inoculum, and to the fermentation conditions. Additionally, the fermentation housing is at least partially permeable to passage of gas therethrough, for example to enable take-up of oxygen, and release of carbon dioxide, during the fermentation process.

FIGS. 5A, 5B, and 5C are schematic illustrations of various implementations of enveloping step 16, according to embodiments of the disclosed technology.

In FIG. 5A, bundle 140 of protein strands 102 are placed in a mold or pan 150. Mold 150 may be rigid, such as a metal mold, or may be flexible, such as a silicone mold. Mold 150 may fully enclose bundle 140, or may partially envelop bundle 140, as illustrated in FIG. 5A.

FIG. 5B shows bundle 140 of protein strands 102 enveloped within an enclosure 152, which functions as the fermentation housing. For example, enclosure 152 may be a bag (e.g. a plastic bag) or an envelope. In the embodiment shown in FIG. 5B, the enveloping step includes pushing bundle 140 into the enclosure 152, and may, in some embodiments, include sealing enclosure.

FIG. 5C illustrates bundle 140 placed onto a film 154. Film 154 is then wrapped around bundle 140, for example in the directions of arrows 156, to envelop the bundle. As such, the fermentation housing of FIG. 5C is formed of film 154 wrapped around the 140 bundle. Film 154 may be any suitable type of film, such as a plastic film, aluminum foil, and the like. Such films may allow penetration of air or oxygen into the enveloped bundle.

In some embodiments, when using film 154, bundling step 14 and enveloping step 16 may be combined in a single step. For example, if a single layer of inoculated protein strands 102 is placed onto film 154, one may lift the ends of the film to envelop the strands, and the lifting motion causes the strands to move toward the center of film 154 and form a bundle, prior to fully wrapping the bundle.

In some embodiments, during said enveloping, a directional orientation of the longitudinal axes of at least 80% of the strands is maintained. In some embodiments, the directional orientation of at least 85%, at least 90%, or at least 95% of the strands is maintained. In the context of the present application, the directional orientation of a strand is considered to be maintained if the directional orientation of the strand is within 10 degrees (and more typically 5 degrees) from its previous, or initial, orientation within the bundle.

In some embodiments, during or following enveloping of bundle 140, the bundle has a bulk density within a range of 0.35 to 0.85 g/cm³.

In some embodiments, the bulk density is within a range of 0.4 to 0.85 g/cm³, 0.5 to 0.85 g/cm³, 0.35 to 0.8 g/cm³, 0.35 to 0.75 g/cm³, 0.35 to 0.7 g/cm³, 0.35 to 0.65 g/cm³, 0.35 to 0.6 g/cm³, 0.4 to 0.8 g/cm³, 0.45 to 0.75 g/cm³, 0.5 to 0.7 g/cm³, or 0.55 to 0.65 g/cm³.

In some embodiments, the bulk density is at most 0.8 g/cm³, at most 0.75 g/cm³, at most 0.70 g/cm³, at most 0.65 g/cm³, or at most 0.60 g/cm³.

In some embodiments, the bulk density is at least 0.40 g/cm³, at least 0.45 g/cm³, at least 0.50 g/cm³, at least 0.55 g/cm³.

In some embodiments, during or following enveloping of bundle 140, a water activity of the bundle is at least 0.6, at least 0.65, at least 0.7, or at least 0.75.

Without wishing to be limited by theory, the inventors believe that the bulk density and the water activity of the bundle, at the time of enveloping thereof, are significant for the success of the fermentation.

In some embodiments, enveloping of bundle 140 protein strands 102 may cause the inoculum to spread over a greater surface area of the protein strands than that achieved during the inoculating or bundling step.

In some embodiments, following the enveloping, the inoculum covers at least 0.1% of a total cumulative surface area of the strands.

Returning to FIG. 1, at step 18 the bundle 140 within the housing is subjected to fermentation, in order to produce a fermented structure. In the context of the present application and claims, the term “subjecting to fermentation” is defined as providing conditions suitable for the fermenting microorganism to carry out fermentation of substances included within strands 102, or to grow on or around such strands. The conditions may include suitable humidity conditions, suitable temperature conditions, suitable access to oxygen or air flow, time allowed for fermentation, and the like. The specific conditions may differ depending on the specific fermenting microorganism used.

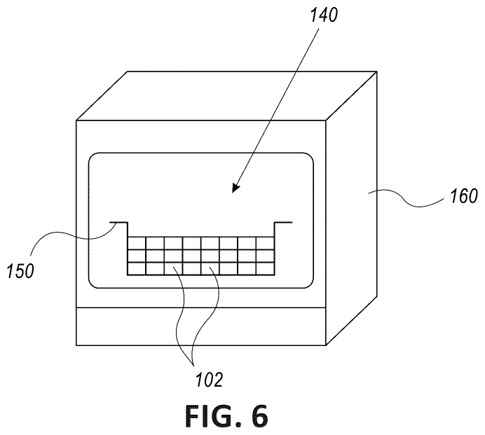

FIG. 6 is a schematic illustration of fermentation step 18. In FIG. 6, mold 150 with bundle 140 disposed therein may be placed in a fermentation chamber 160.

For example, when using Bacillus subtilis as the fermenting microorganism, the fermentation chamber/container may be maintained at 38-45° C., and suitable conditions may be provided for a duration of approximately 24 hours.

As another example, when using Aspergillus oryzae as the fermenting microorganism, fermentation chamber may be maintained at 27-35° C., and suitable conditions may be provided for a duration of approximately 48 hours.

Returning to FIG. 1, following fermentation, the fermented product is removed from the fermentation housing at step 20.

In some embodiments, following fermentation step 18, the fermented structure has a void fraction a range of 5-40%. In some embodiments, the void fraction is in the range of 8-35%, in the range of 10-30%, or in the range of 14-26%.

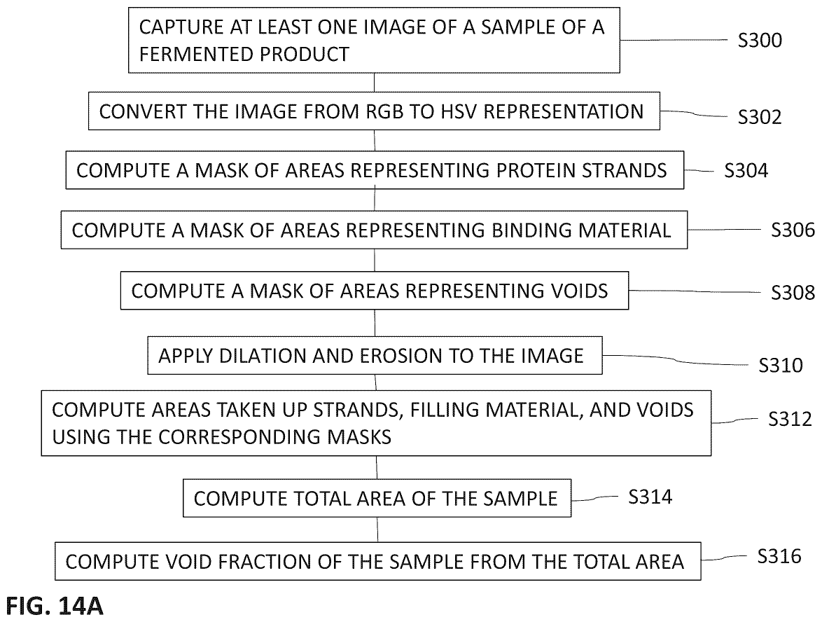

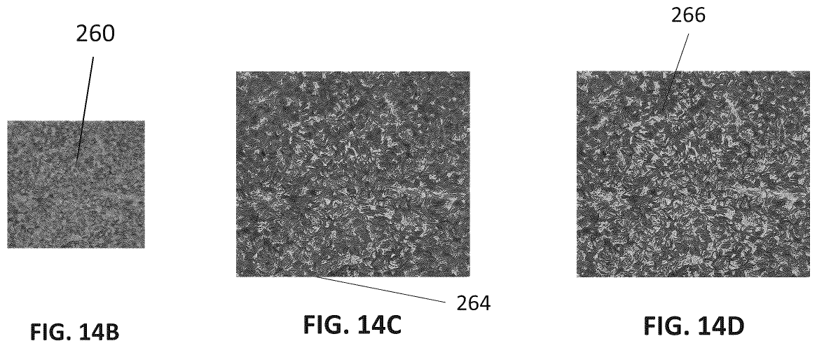

An exemplary method of computing the void fraction of a fermented structure is provided hereinbelow with respect to FIGS. 14A to 14D.

In some embodiments, following fermentation, the fermented structure may be treated in various ways, to obtain the fermented meat analog.

In some embodiments, the treatment following fermentation includes deactivation of the fermenting microorganism in the fermented structure, at step 22. For example, deactivation of the fermenting microorganism may be carried out by application of dry heat, excessive cold, steam, UV irradiation, microwave energy, pasteurization including high-pressure pasteurization, gamma radiation, acid, base, ethanol, fumigation (e.g. with gas), sterilization (e.g. with a liquid chemical) or the like, to the fermented structure.

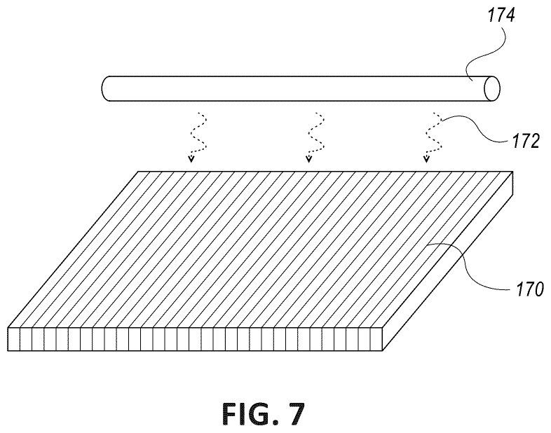

FIG. 7 is an exemplary illustration of irradiation of fermented structure 170, which has been removed from the fermentation housing, with gamma radiation 172, emitted, for example, from a gamma radiation source 174.

In some embodiments, following deactivation of the fermenting microorganism, the fermenting microorganism remains whole in the fermented structure, and is merely deactivated. In other embodiments, the deactivation process may break down the fermenting microorganism, such that only components of the fermenting microorganism, or residue of the fermenting microorganism, remain within the fermented structure.

In some embodiments, the treatment may include addition of liquid to the fermented structure, at step 24.

In some embodiments, the addition of liquid may be carried out following deactivation of the fermenting microorganism at step 22.

In some embodiments, the addition of liquid may be carried out prior to deactivation of the fermenting microorganism.

In some embodiments, the addition of liquid may be carried out following removal of the fermented product from the fermentation housing, such as when deactivating step 22 is skipped.

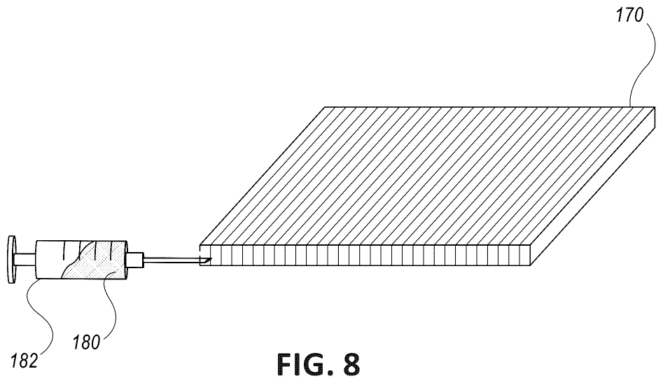

The liquid may be added by any suitable means, such as by injection, marinating, soaking, cooking in a aqueous liquid, and cooking in fat. For example, in FIG. 8, liquid 180 disposed in a syringe 182 is injected into the fermented structure 170.

In some embodiments, the added liquid is absorbed in a matrix formed by the deactivated fermenting microorganism or residue thereof and the protein strands.

In some embodiments, following the addition of liquid, a liquid content of the treated fermented structure is in the range of 50-85%, by weight. In some embodiments, the liquid content of the treated fermented structure is in the range of 55-85% by weight, in the range of 60-85% by weight, in the range of 60-80% by weight, or in the range of 60-75% by weight.

In some embodiments, the liquid may be, or may include, an aqueous liquid. In some embodiments, a weight of the added aqueous liquid is within a range of 15-50% by weight of the fermented product to which the liquid is added, prior to the addition of the aqueous liquid. In some embodiments, the added aqueous liquid has a weight within a range of 20-45%, or 25-40% by weight of the fermented product, prior to the addition of the aqueous liquid.

In some embodiments, the liquid may be, or may include, a fat-containing liquid.

In some embodiments, the fat-containing liquid may be a hydrophobic liquid.

In some embodiments, the fat-containing liquid may be a lipophilic liquid.

In some embodiments, the fat-containing liquid may contain at least 10%, at least 15%, or at least 30% fat, by weight.

In some embodiments, a weight of the added fat-containing liquid is within a range of 1% to 20% by weight relative to the fermented product, prior to the addition of the liquid. In some embodiments, the added fat-containing liquid has a weight within a range of 1% to 15%, 1% to 10%, 1% to 8%, 2% to 8%, 3% to 8%, 3% to 6%, or 3% to 5% by weight of the fermented product, prior to the addition of the fat-containing liquid.

In some embodiments, the liquid may be, or may include, a coloring agent or a flavoring agent.

In some embodiments, the method may terminate following the addition of liquid to the fermented product at step 24. In such embodiments, the treated fermented product is the fermented protein-based meat analog.

In some embodiments, the fermented product, the treated fermented product, and/or the fermented protein-based meat analog has a minimal dimension of at least 3 cm. In some embodiments, the minimal dimension is at least 3.2 cm, at least 3.5 cm, at least 3.8 cm, at least 4 cm, at least 4.5 cm, or at least 5 cm.

In some embodiments, at step 26, the fermented product or the treated fermented product is cut into units, to obtain the fermented protein-based meat analog.

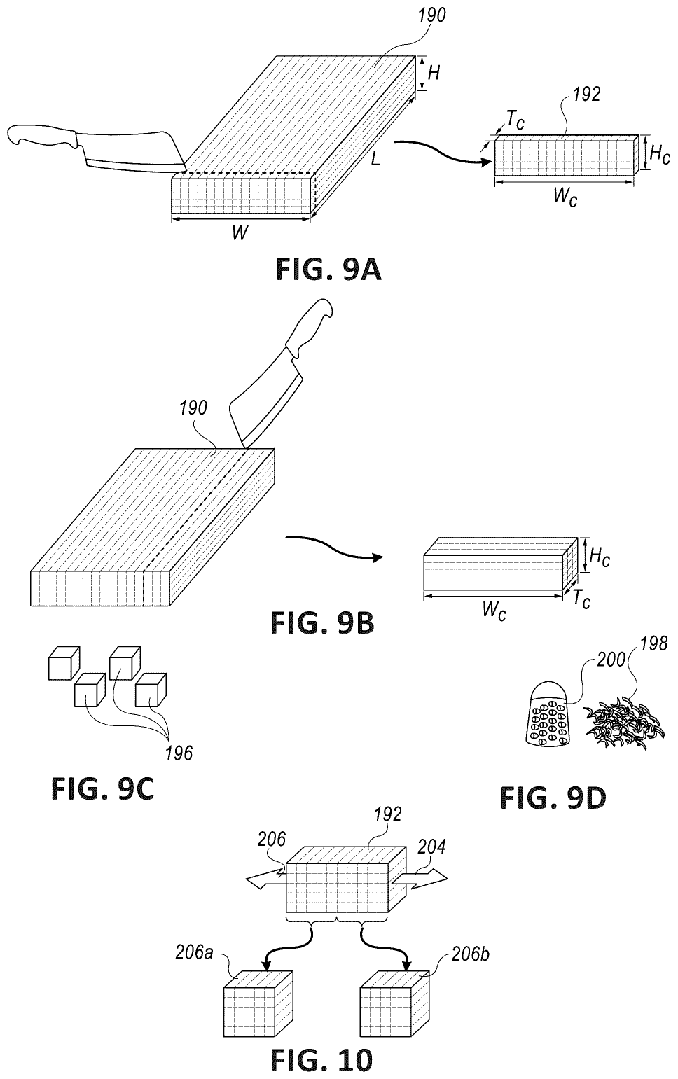

FIGS. 9A, 9B, 9C, and 9D are schematic illustrations of various implementations of cutting step 26, according to embodiments of the disclosed technology.

In some embodiments, and as seen in FIGS. 9A and 9B, fermented structure 190 is sliced, to obtain at least two slices. The slicing may be by any suitable means, such as a knife or a mechanical slicer.

In the embodiment shown in FIG. 9A, fermented structure 190 is cut in a direction perpendicular to the long dimension of the strands thereof, to obtain a slice 192.

In the embodiment shown in FIG. 9B, fermented structure 190 is cut along the long dimension of the strands thereof, to obtain a slice 194.

Slices 192 and 194 each have a thickness dimension indicated by T_{c}, a height dimension indicated by H_{c}, and a width dimension indicated by W_{c} in FIGS. 9A and 9B. The thickness T_{c} is the dimension defined by the distance of the current slice from another slice, during the cutting process. In the embodiment of FIG. 9A, the thickness of slice 192 is along the longitudinal axes of the strands. In the embodiment of FIG. 9B, the thickness of slice 194 is perpendicular to the longitudinal axes of the strands.

In some embodiments, slice 192 or 194 has a thickness in the range of 1 mm to 50 mm, 1 mm to 40 mm, 1 mm to 30 mm, 1 mm to 25 mm, 2 mm to 25 mm, or 3 mm to 25 mm.

In some embodiments, slice 192 or 194 has a width dimension of at least 6 cm, at least 8 cm, at least 10 cm, or at least 12 cm.

In some embodiments, slice 192 or 194 has a height dimension in the range of 4 cm to 10 cm, in the range of 5 cm to 10 cm, in the range of 6 cm to 10 cm, or in the range of 6 cm to 8 cm.

In some embodiments, the cutting at step 26 comprises cutting the fermented structure into chunks. For example, FIG. 9C shows fermented structure 190 cut into chunks resembling cubes 196.

In some embodiments, the cutting at step 26 comprises shredding the fermented structure. For example, FIG. 9D shows fermented structure 190 shredded into a pile 198 of shreds, using a shredding device 200, such as a grater.

It will be appreciated that the steps of deactivation of the fermenting microorganism, addition of liquids, and cutting, may be performed in any suitable order.

The method illustrated in FIG. 1 results in a fermented protein-based meat analog, which includes protein strands and a fermenting microorganism or residue thereof. The fermenting microorganism may or may not be deactivated.

The protein strands of the fermented protein-based meat analog are held together by mycelium, typically deactivated mycelium. The mycelium is formed by the fermenting microorganism during the fermentation step.

In some embodiments, the residue of the fermenting microorganism may include one or more of deactivated mycelium, spores of the fermenting microorganism, DNA of the fermenting microorganism, or a component of a cell wall of the fermenting microorganism, such as ergosterol.

In some embodiments, in addition to the mycelium formed by the fermenting microorganism, components of the inoculum, other than the fermenting microorganism, the deactivated fermenting microorganism or residue thereof, may form part of the binding material binding the strands to one another.

In some embodiments, a fraction of a binding material within the meat analog is at most 15%, by weight. In some embodiments, the fraction of the binding material is at most 12% or at most 10% by weight.

Typically, any binding material utilized is scattered (e.g., randomly) within the meat analog, and is not in the form of layers.

In some embodiments, the meat analog is devoid of layers of binding material.

Reference is now made to FIG. 10, which is a schematic illustration of fracturing of a fermented structure according to the disclosed technology, when force is applied thereto.

As shown in FIG. 10, a slice of the fermented structure, here shown as slice 192 described hereinabove with respect to FIG. 9A, is pulled from opposing ends thereof, for example by a user applying substantially equal pulling forces in the directions of arrows 202 and 204. Typically, when sufficient tensile force is applied to the slice, the slice separates into two pieces, indicated as 206a and 206b. According to embodiments of the disclosed technology, the mechanical failure in slice 192 occurs mostly between protein strands of the slice, and not within protein strands. Stated differently, when slice 192 is split into pieces 206a and 206b, substantially all protein strands 102 of the slice remain in-tact.

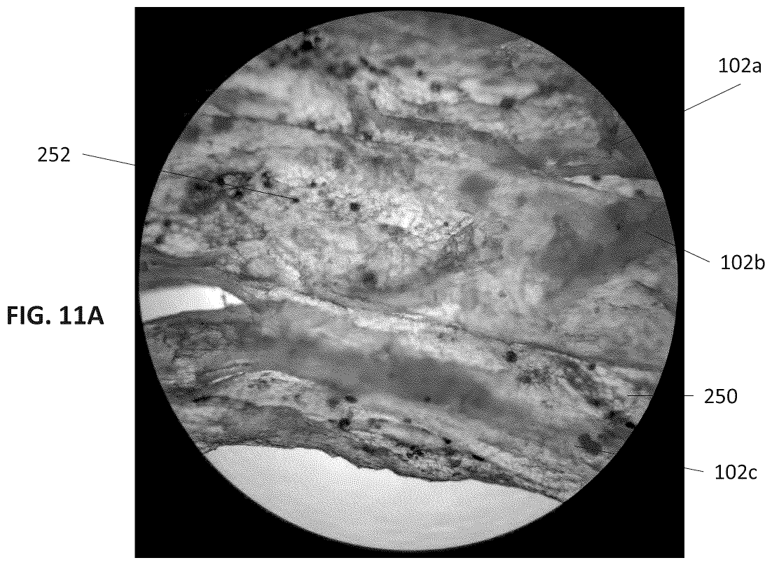

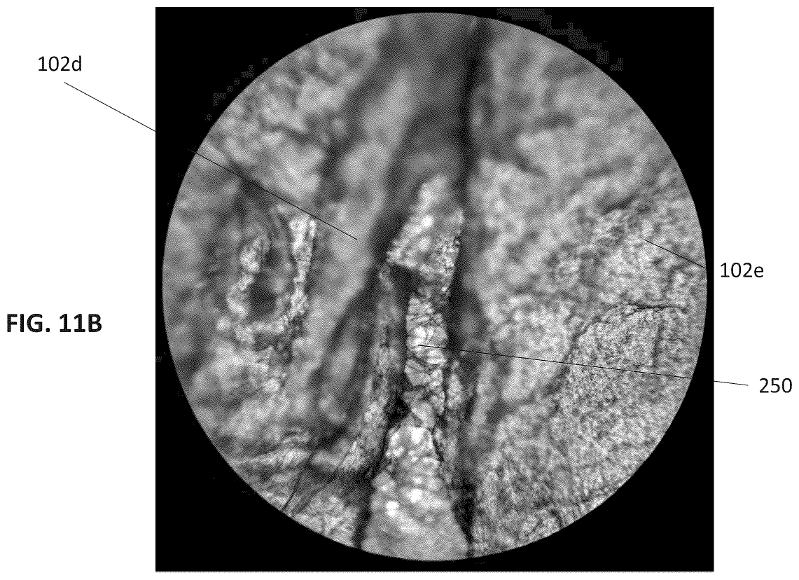

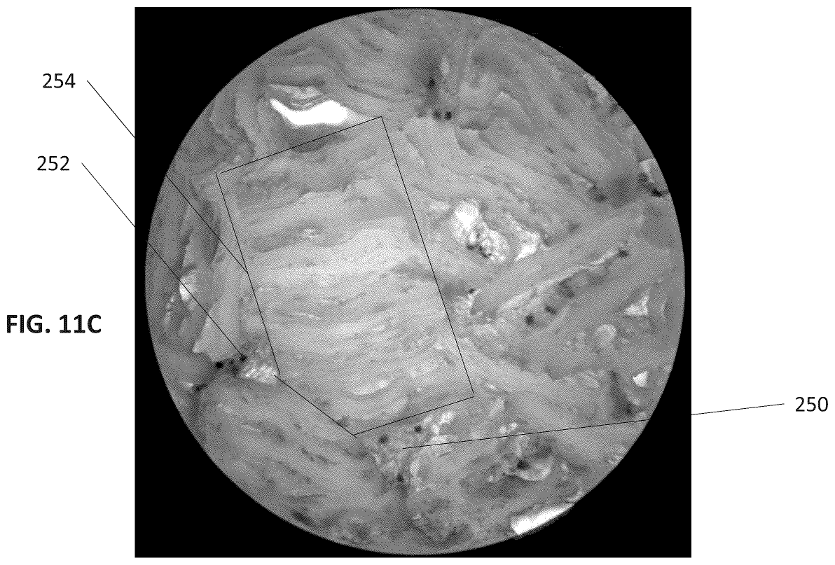

Reference is now made to FIGS. 11A, 11B, and 11C, which are microscopy images of a fermented structure formed during fermentation step 18 of the method of FIG. 1.

The images in FIGS. 11A to 11C were captured using an upright microscope, transilluminated with an LED light source included in the microscope. Samples were prepared by cutting thin slices of the fermented product with a scalpel, or with a deli-slicer, when the fermented product was frozen.

FIG. 11A shows a sample cut along the lengths of the protein strands, at a magnification of 40×. The photo shows three protein stands, labeled 102a, 102b, and 102c, running generally from left to right. The stands are connected to each other by mycelium, or hyphae, indicated by reference numeral 250. Spores of the fermenting microorganism appear as little black spheres 252 within the image.

FIG. 11B shows a sample cut along the lengths of the protein strands, at a magnification of 100×. The photo shows two protein stands, labeled 102d and 102e, running generally from top to bottom. The stands are connected to each other by mycelium, or hyphae, indicated by reference numeral 250. As seen, the mycelium is much clearer, and more developed, in the photo of FIG. 11B than in the Figure of photo 11A.

FIG. 11C shows a sample cut along the lengths of the protein strands, at a magnification of 40×. A complete cross section of a protein stand is shown at reference numeral 254. As seen within the cross section of the strand, the protein strand may include a plurality of layers. The stands are connected to each other by mycelium indicated by reference numeral 250. Spores of the fermenting microorganism appear as little black spheres 252 within the image.

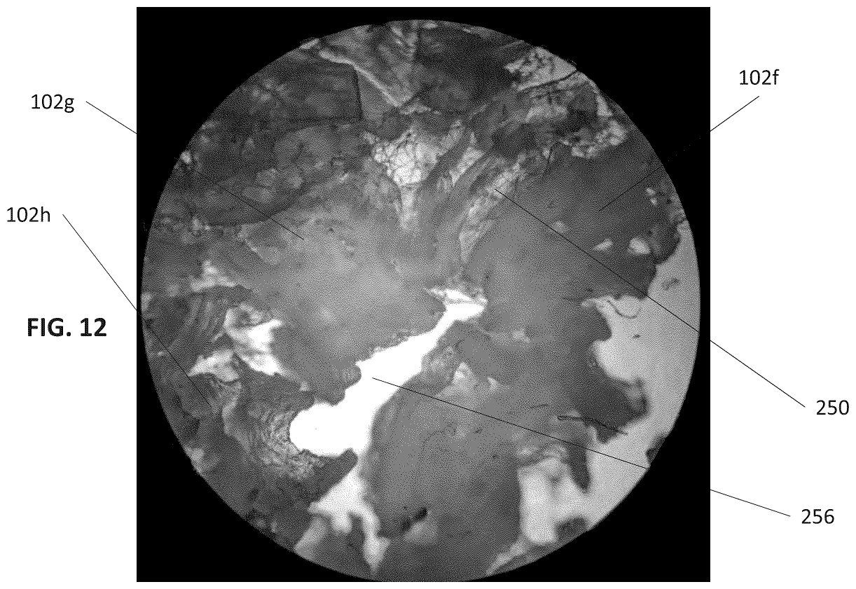

FIGS. 12 is a microscopy image of a fermented structure formed during fermentation step 18 of the method of FIG. 1, and following the deactivation step 22 of the method of FIG. 1.

The image in FIG. 12 was captured using an upright microscope, transilluminated with an LED light source included in the microscope. Samples were prepared using by cutting thin slices of the fermented product with a scalpel, or with a deli-slicer, when the fermented product was frozen.

FIG. 12 shows a sample cut along the lengths of the protein strands, at a magnification of 40×. The photo shows three protein stands, labeled 102f, 102g, and 102h, running generally from left to right. The stands are connected to each other by mycelium, or hyphae, indicated by reference numeral 250. Additionally, following the deactivation step, voids are visible in the fermented structure, as indicated by reference numeral 256.

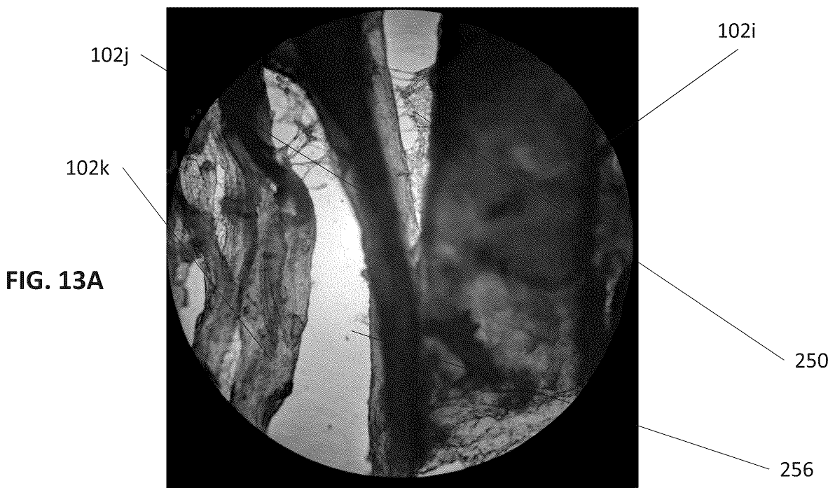

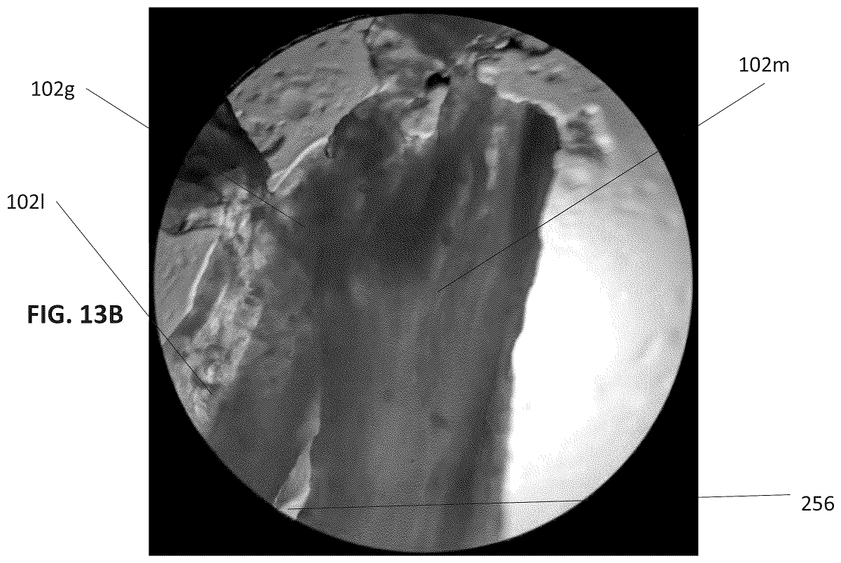

FIGS. 13A and 13B are microscopy images of a fermented protein-based meat analog according to the disclosed technology, following treatment thereof at step 24 of FIG. 1.

The images in FIGS. 13A and 13B were captured using an upright microscope, transilluminated with an LED light source included in the microscope. Samples were prepared using by cutting thin slices of the fermented protein-based meat analog product with a scalpel, or with a deli-slicer, when the fermented protein-based meat analog was frozen.

FIG. 13A shows a sample cut along the lengths of the protein strands, at a magnification of 40×. The photo shows three protein stands, labeled 102i, 102j, and 102k, running generally from top to bottom. Comparison of FIG. 13A to FIG. 11A demonstrates that the color of the strands has changed, due to a coloring agent added to the fermented product. The stands are connected to each other by mycelium, or hyphae, indicated by reference numeral 250. Voids are visible in the fermented structure, as indicated by reference numeral 256.

FIG. 13B shows a sample cut along the lengths of the protein strands, at a magnification of 40×. The photo shows two protein stands, labeled 102l and 102m, running generally from top to bottom.

Reference is now made to FIG. 14A, which is a flow chart of a method of calculating a void percentage of a fermented structure using an image of the fermented structure.

As seen at step S300, initially at least one image of a sample of the fermented product is captured. The image may be taken from the entire fermented product, or from a slice thereof.

While the image may be captured from a direction substantially perpendicular to the longitudinal axis of the majority of the fibers, this need not necessarily be the case.

An exemplary image of a sample 260 of a fermented structure according to the disclosed technology is shown in FIG. 14B.

If the image is represented as RGB (Red-Green-Blue) values, the image is converted to HSV (Hue-Saturation Value) at step S302.

At step S304, a mask of the image including areas of the image representing protein strands is computed using pre-determined saturation and intensity values for the protein strands. In some embodiments, the saturation and intensity values may be dependent on the chemical and physical properties of the protein-based from which the protein strands are formed.

Similarly, at steps S306 and S308, masks of the image including areas of the image representing binding materials and voids between the strands, respectively, are computed using respective pre-determined saturation and intensity values for the binding materials and for the voids between the strands.

FIGS. 14C and 14D show exemplary masks 264 and 266 of the image of sample 260 shown in FIG. 14B, each computed using different pre-determined saturation and intensity values. The exemplary masks 264 and 266 are masks representing the protein strand in the sample.

At step S310, dilation and erosion may be applied to the masked image, to further refine the image and better define the morphology and the outline of the strands as shown therein.

At step S312, the areas of the image taken up by each of the protein strands, the binding material, and the void are computed from the respective masks generated at steps S304, S306, and S308. The total area of the sample is computed at step S314.

At step S316, the void fraction in the sample may be computed by subtracting the area of the image taken up by the voids from the total area of the image. Alternately, the void fraction in the sample may be computed by subtracting the area of the image taken up by the voids from the total area of the image.

For example, using the image of FIG. 14B and the masks of FIG. 14C and 14D, the void fraction in the sample is computed to be in the range of 14% (FIG. 14C) and 24% (FIG. 14D).

In some embodiments, the methods of the disclosed technology are suitable for obtaining a fibrous meat-like fermented protein-based meat analog, or meat analog, with many of the organoleptic properties of actual meat. The term “organoleptic” refers to any sensory properties of a product, such as taste, color, odor, and/or haptic feel. The meat analog has oriented strands, or fibers, that resemble the structure of cuts of meat like sirloin or chuck. In addition, the inventive method enables the manufacturer to control the composition of the meat analog, and to alter its organoleptic properties and/or nutritional properties, for example by modifications to the fermentation step or to the treatment step of the method of FIG. 1.

In some embodiments, the mold in which the protein strands are fermented is selected to provide part of the organoleptic properties of the meat analog. For example, the mold may have an ovoid cross section, having a major diameter and a minor diameter having a ratio in the range of 1:1 to 5:1. Such an ovoid mold provides a meat analog which is similar in its form to a meat cutlet.

In some embodiments, the inoculum may include agents to assist in creating, or enhancing, specific properties of the meat analog. For example, the inoculum may enable addition or removal of nutrients, aroma components, or flavor components, or may enable control, or modification, of properties of the meat analog, such as its texture, fat holding capacity, water holding capacity, palatability, color development before and during cooking, pH and nutritional values. Such modifications can also be achieved by appropriate selection of a fermentation protocol, or by inducing predefined biochemical reactions that result in specific properties.

### Additional Embodiments

Additional Embodiments 1 to 404 are provided hereinbelow.
Embodiment 1. A method of manufacturing a fermented protein-based food item, the method comprising:
a. obtaining protein strands of a protein-based substance containing at least 25% protein, by weight, on a dry basis, wherein said strands have a dimensionless aspect ratio ASP defined by:

$$ASP = {L}^{2} / Ax$$

wherein:
   L is the average length of the long dimension said strands; and
   Ax is the average cross-sectional area of the strand dimensions transverse to said long dimension;
and wherein ASP is at least 100;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

Embodiment 2. A method of manufacturing a fermented protein-based food item, the method comprising:
a. obtaining protein strands of a protein-based substance containing at least 25% protein, by weight on a dry basis;
b. inoculating a surface of the protein strands with an inoculum including a fermenting microorganism, the inoculating being performed layer-by-layer on layers of the protein strands;
c. following the inoculating, bundling the protein strands to produce a bundle of strands;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

Embodiment 3. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism, such that the inoculum covers surface area of the strands in the range of 0.1% to 50% of a total cumulative surface area of the strands;
c. bundling the protein strands to produce a bundle of strands;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

Embodiment 4. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure, wherein, at the time of the subjecting to fermentation, the inoculum covers a surface area of the strands in the range of 0.1% to 50% of a total cumulative surface area of the strands; and
f. treating the fermented structure to produce the fermented protein-based food item.

Embodiment 5. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands, wherein, within the bundle of strands, longitudinal axes of at least 80% of the protein strands are within 30 degrees of the longitudinal axis of the bundle;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

Embodiment 6. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands, while maintaining a directional orientation of longitudinal axes of at least 80% of the protein strands relative to each other;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

Embodiment 7. A method of manufacturing a fermented protein-based food item, the method comprising:
a. obtaining protein strands of a protein-based substance containing at least 50% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing, while maintaining a directional orientation of longitudinal axes of at least 80% of the protein strands relative to each other;
e. subjecting the inoculated bundle of strands to fermentation to produce a fermented structure; and
f. treating the fermented structure to produce the fermented protein-based food item.

Embodiment 8. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure having a minimal dimension greater than 3 cm; and
f. treating the fermented structure to produce the fermented protein-based food item.

9. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands, the bundle of strands having a bulk density within a range of 0.35 to 0.85 g/cm³;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

Embodiment 10. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure, the fermented structure having a void fraction within a range of 5-40%; and
f. treating the fermented structure to produce the fermented protein-based food item.

Embodiment 10A. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands, with an inoculum including a fermenting microorganism, such that for at least one of the protein strands, the colony forming unit (CFU) count of the fermenting microorganism with respect to the cumulative surface area of the at least one of the protein strands is 10-10⁴ CFU/cm²;
c. bundling the protein strands to produce a bundle of strands;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

Embodiment 10B. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands, with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure, wherein, at the time of the subjecting to fermentation, the colony forming unit (CFU) count of the fermenting microorganism in the inoculum on at least one of the protein strands, with respect to the cumulative surface area of the at least one of the protein strands, is 10-10⁴ CFU/cm²; and
f. treating the fermented structure to produce the fermented protein-based food item.

Embodiment 10C. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands, with an inoculum including a fermenting microorganism, such that for at least one of the protein strands, the colony forming unit (CFU) count of the fermenting microorganism divided by the cumulative weight of the at least one of the protein strands is 1000-100,000 CFU/gram;
c. bundling the protein strands to produce a bundle of strands;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

Embodiment 10D. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure, wherein, at the initial time of the subjecting to fermentation, the colony forming unit (CFU) count of the fermenting microorganism for at least one of the protein strands, divided by the cumulative weight of the at least one of the protein strands, is 1000-100,000 CFU/gram; and
f. treating the fermented structure to produce the fermented protein-based food item.

Embodiment 10E. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism, such that for at least one of the protein strands, the weight of the inoculum is 0.1-10% of the weight of the at least one of the protein strands;
c. bundling the protein strands to produce a bundle of strands;
d. following steps b and c, enveloping the bundle of strands in a fermentation housing;
e. subjecting the inoculated bundle of strands to fermentation to produce a fermented structure; and
f. treating the fermented structure to produce the fermented protein-based food item.

Embodiment 10F. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure, wherein, at the time of the subjecting to fermentation, the weight of the inoculum disposed on at least one of the protein strands, is 0.1-10% of the weight of the at least one of the protein strands; and
f. treating the fermented structure to produce the fermented protein-based food item.

Embodiment 10G. The method of any one of Embodiments 10A to 10F, wherein the at least one of the protein strands is all of the protein stands in the bundle.

Embodiment 11. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing, wherein a water activity of the inoculated enveloped bundle of strands is at least 0.6;
e. subjecting the inoculated bundle of strands to fermentation to produce a fermented structure; and
f. treating the fermented structure to produce the fermented protein-based food item.

Embodiment 12. The method of any one of Embodiments 1 to 11, wherein the treating includes deactivating the fermenting microorganism.

Embodiment 13. The method of any one of Embodiments 1 to 12, wherein the treating includes adding liquid to the fermented structure.

Embodiment 14. The method of any one of Embodiments 1 to 11, wherein the treating includes deactivating the fermenting microorganism and adding liquid to the fermented structure.

Embodiment 15. The method of Embodiment 14, wherein the deactivating is performed prior to the adding.

Embodiment 16. The method of Embodiment 14, wherein the deactivating is performed following the adding.

1 Embodiment 7. The method of any one of Embodiments 1 to 16, wherein the treating includes cutting the fermented structure.

Embodiment 18. The method of any one of Embodiments 1 to 16, wherein the treating includes cutting the fermented structure and adding liquid to the fermented structure.

Embodiment 19. The method of Embodiment 18, wherein the cutting is performed prior to the adding.

Embodiment 20. The method of Embodiment 18, wherein the cutting is performed following the adding.

Embodiment 21. The method of any one of Embodiments 1 to 20, wherein the treating includes deactivating the fermenting microorganism and cutting the fermented structure.

Embodiment 22. The method of Embodiment 21, wherein the deactivating is performed prior to the cutting.

Embodiment 23. The method of Embodiment 21, wherein the deactivating is performed following the cutting.

Embodiment 24. The method of any one of Embodiments 1 to 23, further comprising, prior to the treating, removing the fermented structure from the fermentation housing.

Embodiment 25. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure;
f. removing the fermented structure from the fermentation housing;
g. deactivating the fermenting microorganism within the fermented structure; and
h. adding liquid to the fermented structure to obtain the fermented protein-based food item, such that following the adding of the liquid, a liquid content of the fermented protein-based food item is within a range of 50 to 85%, by weight.

Embodiment 26. The method of any one of the preceding Embodiments, wherein a matrix formed by i) the deactivated fermenting microorganism or ii) a residue thereof, and the protein strands, absorbs the added liquid.

Embodiment 27. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure;
f. removing the fermented structure from the fermentation housing; and
g. adding an aqueous liquid to the fermented structure to obtain the fermented protein-based food item, wherein the aqueous liquid comprises 15 to 50%, by weight, of the fermented product, prior to the adding.

Embodiment 28. A method of manufacturing a fermented protein-based food item, the method comprising:
a. obtaining protein strands of a protein-based substance containing at least 25% protein, by weight, on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure;
f. removing the fermented structure from the fermentation housing; and
g. adding a liquid containing fat or a lipophilic liquid to the fermented structure to obtain the fermented protein-based food item, wherein the liquid containing fat or lipophilic liquid comprises 1 to 20%, by weight, of the fermented product, prior to the adding.

Embodiment 29. The method of Embodiment 27 or Embodiment 28, further comprising at least one of deactivating the fermenting microorganism and cutting the fermented structure.

Embodiment 30. The method of any one of Embodiments 27 to 29, further comprising deactivating the fermenting microorganism.

Embodiment 31. The method of Embodiment 29 or Embodiment 30, wherein the deactivating is performed prior to the adding.

Embodiment 32. The method of Embodiment 29 or Embodiment 30, wherein the deactivating is performed following the adding.

Embodiment 33. The method of any one of Embodiments 25 to 32, further comprising, cutting the fermented structure.

Embodiment 34. The method of any one of Embodiments 25 to 32, comprising both deactivating the fermenting microorganism and cutting the fermented structure.

Embodiment 35. The method of Embodiment 34, wherein the deactivating occurs prior to the cutting.

Embodiment 36. The method of Embodiment 34, wherein the deactivating occurs following the cutting.

Embodiment 37. The method of any one of Embodiments 33 to 36, wherein the adding is performed prior to the cutting.

Embodiment 38. The method of any one of Embodiments 33 to 36, wherein the adding is performed following the cutting.

Embodiment 39. A method of manufacturing a fermented protein-based food item, the method comprising:
a. obtaining protein strands of a protein-based substance containing at least 25% protein, by weight on a dry basis;
b. inoculating at least one of i) the protein-based substance and ii) the protein strands with an inoculum including a fermenting microorganism;
c. bundling the protein strands to produce a bundle of strands;
d. following steps b and c, enveloping the bundle of strands in a fermentation housing;
e. subjecting the inoculated bundle of strands to fermentation to produce a fermented structure;
f. removing the fermented structure from the fermentation housing;
g. treating the fermented structure; and
h. cutting the fermented structure to obtain the fermented protein-based food item.

Embodiment 40. The method of Embodiment 39, wherein the treating includes deactivating the fermenting microorganism.

Embodiment 41. The method of Embodiment 39 or Embodiment 40, wherein the treating includes adding liquid to the fermented structure.

Embodiment 42. The method of Embodiment 40 or Embodiment 41, wherein the deactivating occurs prior to the cutting.

Embodiment 43. The method of Embodiment 40 or Embodiment 41, wherein the deactivating occurs following the cutting.

Embodiment 44. The method of any one of Embodiments 41 to 43, wherein the adding occurs prior to the cutting.

Embodiment 45. The method of any one of Embodiments 41 to 43, wherein the adding occurs following the cutting.

Embodiment 46. The method of Embodiment 41 to 45, wherein the deactivating occurs prior to the adding.

Embodiment 47. The method of Embodiment 41 to 45, wherein the deactivating occurs following the adding.

Embodiment 48. The method of any one of Embodiments 1 to 47, wherein the protein-based substance contains at least 30% protein by weight on a dry basis.

Embodiment 49. The method of Embodiment 48, wherein the protein-based substance contains at least 40% protein by weight on a dry basis.

Embodiment 50. The method of Embodiment 48, wherein the protein-based substance contains at least 50% protein by weight on a dry basis.

Embodiment 51. The method of any one of Embodiments 1 to 50, wherein the protein of the protein-based substance includes plant protein.

Embodiment 52. The method of Embodiment 51, wherein the protein of the protein-based substance predominantly includes the plant protein.

Embodiment 53. The method of Embodiment 51, wherein the protein of the protein-based substance consists essentially of the plant protein.

Embodiment 54. The method of any one of Embodiments 1 to 53, wherein the protein of the protein-based substance includes soy protein.

Embodiment 55. The method of any one of Embodiments 1 to 54, wherein the protein of the protein-based substance includes extruded protein.

Embodiment 56. The method of Embodiment 55, wherein the protein of the protein-based substance predominantly includes the extruded protein.

Embodiment 57. The method of Embodiment 55 or Embodiment 56, wherein the extruded protein is extruded vegetable protein.

Embodiment 58. The method of any one of Embodiments 55 to 57, wherein the protein of the protein-based substance includes denatured protein.

Embodiment 59. The method of Embodiment 58, wherein the protein of the protein-based substance predominantly includes extruded protein.

Embodiment 60. The method of any one of Embodiments 1 to 59, wherein the protein of the protein-based substance includes a cross-linked protein.

Embodiment 61. The method of Embodiment 60, wherein the protein of the protein-based substance predominantly includes the cross-linked protein.

Embodiment 62. The method of any one of Embodiments 1 to 61, wherein the obtaining comprises obtaining a piece of the protein-based substance, and cutting the piece into the strands.

Embodiment 63. The method of any one of Embodiments 1 to 62, wherein the obtaining comprises extruding the strands of the protein-based substance.

Embodiment 64. The method of any one of Embodiments 1 to 63, wherein the fermentation housing comprises a rigid mold.

Embodiment 65. The method of any one of Embodiments 1 to 63, wherein the fermentation housing comprises a flexible mold.

Embodiment 66. The method of any one of Embodiments 1 to 63, wherein the fermentation housing comprises a bag or envelope.

Embodiment 67. The method of any one of Embodiments 1 to 66, wherein the fermentation housing comprises a film, and the enveloping comprises wrapping the film around the bundle to envelop the bundle.

Embodiment 68. The method of any one of Embodiments 1 to 67, wherein the fermentation housing is permeable to flow of gas therethrough.

Embodiment 69. The method of any one of Embodiments 2 to 68, wherein the obtaining comprises obtaining strands having a maximal dimension, in a cross-section of a longitudinal axis thereof, in the range of 0.5 mm to 5 mm.

Embodiment 70. The method of Embodiment 69, wherein the maximal dimension is in the range of 0.5 mm to 4 mm.

Embodiment 71. The method of Embodiment 69, wherein the maximal dimension is in the range of 0.5 mm to 3 mm.

Embodiment 72. The method of Embodiment 69, wherein the maximal dimension is in the range of 0.5 mm to 2 mm.

Embodiment 73. The method of Embodiment 69, wherein the maximal dimension is in the range of 1 mm to 2 mm.

Embodiment 74. The method of any one of Embodiments 2 to 68, wherein, prior to the bundling, an average length of a long dimension of the strands is at least 5 mm.

Embodiment 75. The method of Embodiment 74, wherein the average length is at least 10 mm.

Embodiment 76. The method of Embodiment 74, wherein the average length is at least 15 mm.

Embodiment 77. The method of Embodiment 74, wherein the average length is at least 20 mm.

Embodiment 78. The method of Embodiment 74, wherein the average length is at least 40 mm.

Embodiment 79. The method of Embodiment 74, wherein the average length is at least 70 mm.

Embodiment 80. The method of Embodiment 74, wherein the average length is at least 100 mm.

Embodiment 81. The method of Embodiment 74, wherein the average length is at least 150 mm.

Embodiment 82. The method of Embodiment 74, wherein the average length is at least 250 mm.

Embodiment 83. The method of Embodiment 74, wherein the average length is at least 400 mm.

Embodiment 84. The method of any one of Embodiments 74 to 83, wherein the average length is at most 1000 mm.

Embodiment 85. The method of Embodiment 84, wherein the average length is at most 700 mm.

Embodiment 86. The method of any one of Embodiments 1 to 68, wherein said strands have a dimensionless aspect ratio ASP defined by:

$$ASP = {L}^{2} / Ax$$

wherein:
   L is the average length of the long dimension said strands; and
   Ax is the average cross-sectional area of the strand dimensions transverse to said long dimension;
and wherein ASP is at least 105.

Embodiment 87. The method of Embodiment 86, wherein ASP is at least 250.

Embodiment 88. The method of Embodiment 86, wherein ASP is at least 500.

Embodiment 89. The method of Embodiment 86, wherein ASP is at least 750.

Embodiment 90. The method of Embodiment 86, wherein ASP is at least 1,000.

Embodiment 90A. The method of Embodiment 86, wherein ASP is at least 1,500.

Embodiment 90B. The method of Embodiment 86, wherein ASP is at least 2,000.

Embodiment 90C. The method of Embodiment 86, wherein ASP is at least 2,500.

Embodiment 90D. The method of Embodiment 86, wherein ASP is at least 3,000.

Embodiment 90E. The method of Embodiment 86, wherein ASP is at least 4,000.

Embodiment 90F. The method of Embodiment 86, wherein ASP is at least 5,000.

Embodiment 90G. The method of Embodiment 86, wherein ASP is at least 6,000.

Embodiment 90H. The method of Embodiment 86, wherein ASP is at least 8,000.

Embodiment 91. The method of Embodiment 86, wherein ASP is at least 10,000.

Embodiment 92. The method of Embodiment 86, wherein ASP is at least 50,000.

Embodiment 93. The method of Embodiment 86, wherein ASP is at least 100,000.

Embodiment 94. The method of any one of Embodiments 86 to 93, wherein ASP is at most 5,000,000.

Embodiment 95. The method of Embodiment 94, wherein ASP is at most 1,000,000.

Embodiment 96. The method of any one of Embodiments 1 and Embodiments 86 to 95, wherein Ax is within a range of 0.25 mm² to 25 mm².

Embodiment 97. The method of Embodiment 96, wherein Ax is within a range of 1 mm² to 25 mm².

Embodiment 98. The method of any one of Embodiments 1 and Embodiments 86 to 97, wherein L is within a range of 5 mm to 600 mm.

Embodiment 99. The method of Embodiment 98, wherein L is at least 5.5 mm.

Embodiment 100. The method of Embodiment 98, wherein L is at least 6 mm.

Embodiment 101. The method of Embodiment 98, wherein L is at least 8 mm.

Embodiment 102. The method of Embodiment 98, wherein L is at least 10 mm.

Embodiment 103. The method of Embodiment 98, wherein L is at least 15 mm.

Embodiment 104. The method of Embodiment 98, wherein L is at least 20 mm.

Embodiment 105. The method of Embodiment 98, wherein L is at least 50 mm.

Embodiment 106. The method of Embodiment 98, wherein L is at least 100 mm.

Embodiment 107. The method of Embodiment 98, wherein L is at least 250 mm.

Embodiment 108. The method of Embodiment 98, wherein L is at least 500 mm.

Embodiment 109. The method of Embodiment 1 or any one of Embodiments 3 to 108, wherein the inoculating comprises inoculating the protein strands, prior to the bundling.

Embodiment 110. The method of Embodiment 2 or Embodiment 109, wherein the inoculating is performed layer-by-layer, prior to the bundling.

Embodiment 111. The method of Embodiment 110, wherein the inoculating of each layer comprises scattering the inoculum over one side of the layer.

Embodiment 112. The method of Embodiment 110 or Embodiment 111, wherein the inoculating of each layer comprises blowing the inoculum onto the strands of the layer.

Embodiment 113. The method of any one of Embodiments 110 to 112, wherein the inoculating of each layer comprises spraying a liquid suspension including the inoculum onto the strands of the layer.

Embodiment 114. The method of any one of Embodiments 110 to 113, wherein the inoculating of each layer comprises dipping the strands of the layer in a liquid suspension including the inoculum.

Embodiment 115. The method Embodiment 1 or any one of Embodiments 3 to 108, wherein the inoculating comprises inoculating the protein strands, following the bundling.

Embodiment 116. The method of Embodiment 1 or any one of Embodiments 3 to 108, wherein the inoculating comprises inoculating the protein-based substance, prior to forming the protein strands thereof.

Embodiment 117. The method of Embodiment 1 or any one of Embodiments 3 to 108, wherein the inoculating comprises blowing the inoculum onto the strands, into or onto the bundle or into or onto the protein-based substance.

Embodiment 118. The method of Embodiment 1 or any one of Embodiments 3 to 108, wherein the inoculating comprises spraying a liquid suspension including the inoculum onto the strands, the bundle, or the protein-based substance.

Embodiment 119. The method of Embodiment 1 or any one of Embodiments 3 to 108, wherein the inoculating comprises dipping the protein-based substance, the strands, or the bundle in a liquid suspension including the inoculum.

Embodiment 120. The method of Embodiment 1, Embodiment 2, or any one of Embodiments 4 to 119, wherein, prior to the bundling, the inoculum covers 0.1% to 50% of the surface area of the strands.

Embodiment 121. The method of Embodiment 120, wherein, prior to the bundling, the inoculum covers at least 0.5% of the surface area of the strands.

Embodiment 122. The method of Embodiment 120, wherein, prior to the bundling, the inoculum covers at least 1.5% of the surface area of the strands.

Embodiment 123. The method of Embodiment 120, wherein, prior to the bundling, the inoculum covers at least 4% of the surface area of the strands.

Embodiment 124. The method of Embodiment 120, wherein, prior to the bundling, the inoculum covers at least 8% of the surface area of the strands.

Embodiment 125. The method of Embodiment 120, wherein, prior to the bundling, the inoculum covers at least 15% of the surface area of the strands.

Embodiment 126. The method of Embodiment 3 or any one of Embodiments 120 to 125, wherein, prior to the bundling, the inoculum covers at most 45% of the surface area of the strands.

Embodiment 127. The method of Embodiment 126, wherein, prior to the bundling, the inoculum covers at most 40% of the surface area of the strands.

Embodiment 128. The method of Embodiment 126, wherein, prior to the bundling, the inoculum covers at most 35% of the surface area of the strands.

Embodiment 129. The method of Embodiment 3 or any one of Embodiments 120 to 125, wherein, prior to the bundling, the inoculum covers 1% to 40% of the surface area of the strands.

Embodiment 130. The method of any one of Embodiments 1 to 3 or of any one of Embodiments 5 to 129, wherein, following the bundling, the inoculum covers 1% to 95% of the surface area of the strands.

Embodiment 131. The method of Embodiment 130, wherein, following the bundling, the inoculum covers at least 2% of the surface area of the strands.

Embodiment 134. The method of Embodiment 130, wherein, following the bundling, the inoculum covers at least 4% of the surface area of the strands.

Embodiment 135. The method of Embodiment 130, wherein, following the bundling, the inoculum covers at least 6% of the surface area of the strands.

Embodiment 136. The method of Embodiment 130, wherein, following the bundling, the inoculum covers at least 10% of the surface area of the strands.

Embodiment 137. The method of Embodiment 130, wherein, following the bundling, the inoculum covers at least 15% of the surface area of the strands.

Embodiment 138. The method of Embodiment 130, wherein, following the bundling, the inoculum covers at least 20% of the surface area of the strands.

Embodiment 139. The method of Embodiment 130, wherein, following the bundling, the inoculum covers at least 25% of the surface area of the strands.

Embodiment 140. The method of Embodiment 130, wherein, following the bundling, the inoculum covers at least 30% of the surface area of the strands.

Embodiment 141. The method of Embodiment 4 or any one of Embodiments 130 to 140, wherein, following the bundling, the inoculum covers at most 90% of the surface area of the strands.

Embodiment 142. The method of Embodiment 141, wherein, following the bundling, the inoculum covers at most 85% of the surface area of the strands.

Embodiment 142A. The method of Embodiment 141, wherein, following the bundling, the inoculum covers at most 80% of the surface area of the strands.

Embodiment 142B. The method of Embodiment 141, wherein, following the bundling, the inoculum covers at most 75% of the surface area of the strands.

Embodiment 143. The method of any one of the preceding Embodiments, wherein, within the bundle of strands, longitudinal axes of at least 80% of the strands are within 30 degrees of the longitudinal axis of the bundle.

Embodiment 144. The method of Embodiment 143, wherein, within the bundle of strands, the longitudinal axes of at least 85% of the strands are within 30 degrees of the longitudinal axis of the bundle.

Embodiment 145. The method of Embodiment 143, wherein, within the bundle of strands, the longitudinal axes of at least 90% of the strands are within 30 degrees of the longitudinal axis of the bundle.

Embodiment 146. The method of Embodiment 143, wherein, within the bundle of strands, the longitudinal axes of at least 95% of the strands are within 30 degrees of the longitudinal axis of the bundle.

Embodiment 147. The method any one of the preceding Embodiments, wherein, within the bundle of strands, the longitudinal axes of at least 80% of the strands are within 25 degrees of the longitudinal axis of the bundle.

Embodiment 148. The method of Embodiment 147, wherein, within the bundle of strands, the longitudinal axes of at least 80% of the strands are within 20 degrees of the longitudinal axis of the bundle.

Embodiment 149. The method of Embodiment 147, wherein, within the bundle of strands, the longitudinal axes of at least 80% of the strands are within 15 degrees of the longitudinal axis of the bundle.

Embodiment 150. The method of Embodiment 147, wherein, within the bundle of strands, the longitudinal axes of at least 80% of the strands are within 10 degrees of the longitudinal axis of the bundle.

Embodiment 151. The method of Embodiment 147, wherein, within the bundle of strands, the longitudinal axes of at least 80% of the strands are within 5 degrees of the longitudinal axis of the bundle.

Embodiment 152. The method of any one of Embodiments 1 to 5 or any one of Embodiments 7 to 151, wherein, during said bundling, the directional orientation of longitudinal axes of at least 80% of the strands is maintained.

Embodiment 153. The method of Embodiment 6 or Embodiment 152, wherein, during said bundling, the directional orientation of the longitudinal axes of at least 85% of the strands is maintained.

Embodiment 154. The method of Embodiment 153, wherein, during said bundling, the directional orientation of the longitudinal axes of at least 90% of the strands is maintained.

Embodiment 155. The method of Embodiment 153, wherein, during said bundling, the directional orientation of the longitudinal axes of at least 95% of the strands is maintained.

Embodiment 156. The method of any one of Embodiments 1 to 6 or any one of Embodiments 8 to 155, wherein, during said enveloping, the directional orientation of the longitudinal axes of at least 80% of the strands is maintained.

Embodiment 157. The method of Embodiment 7 or Embodiment 156, wherein, during said enveloping, the directional orientation of the longitudinal axes of at least 85% of the strands is maintained.

Embodiment 158. The method of Embodiment 157, wherein, during said enveloping, the directional orientation of the longitudinal axes of at least 90% of the strands is maintained.

Embodiment 159. The method of Embodiment 157, wherein, during said enveloping, the directional orientation of the longitudinal axes of at least 95% of the strands is maintained.

Embodiment 160. The method of any one of Embodiments 1 to 7 or 9 to 159, wherein the fermented plant-protein based food item has a minimal dimension greater than 3 cm.

Embodiment 161. The method of Embodiment 8 or Embodiment 160, wherein the minimal dimension of the ferment plant-protein based food item is greater than 3.2 cm.

Embodiment 162. The method of Embodiment 161, wherein the minimal dimension of the ferment plant-protein based food item is greater than 3.5 cm.

Embodiment 163. The method of 161, wherein the minimal dimension of the ferment plant-protein based food item is greater than 3.8 cm.

Embodiment 164. The method of Embodiment 161, wherein the minimal dimension of the ferment plant-protein based food item is greater than 4 cm.

Embodiment 165. The method of Embodiment 161, wherein the minimal dimension of the ferment plant-protein based food item is greater than 4.5 cm.

Embodiment 166. The method of Embodiment 161, wherein the minimal dimension of the ferment plant-protein based food item is greater than 5 cm.

Embodiment 167. The method of any one of Embodiments 8 and Embodiments 160 to 166, wherein the minimal dimension of the ferment plant-protein based food item is at most 20 cm.

Embodiment 168. The method of Embodiment 167, wherein the minimal dimension of the ferment plant-protein based food item is at most 9 cm.

Embodiment 169. The method of any one of Embodiments 1 to 8 or 10 to 168, wherein, prior to the subjecting, the bundle of protein strands has a bulk density within a range of 0.35 to 0.85 g/cm³.

Embodiment 170. The method of Embodiment 9 or Embodiment 169, wherein the bulk density is at most 0.8 g/cm³.

Embodiment 171. The method of Embodiment 170, wherein the bulk density is at most 0.75 g/cm³.

Embodiment 172. The method of Embodiment 170, wherein the bulk density is at most 0.70 g/cm³.

Embodiment 173. The method of Embodiment 170, wherein the bulk density is at most 0.65 g/cm³.

Embodiment 174. The method of Embodiment 170, wherein the bulk density is at most 0.60 g/cm³.

Embodiment 175. The method of Embodiment 9 or any one of Embodiments 169 to 174, wherein the bulk density is at least 0.40 g/cm³.

Embodiment 176. The method of Embodiment 9 or any one of Embodiments 169 to 174, wherein the bulk density is at least 0.45 g/cm³.

Embodiment 177. The method of Embodiment 9 or any one of Embodiments 169 to 174, wherein the bulk density is at least 0.50 g/cm³.

Embodiment 178. The method of Embodiment 9 or any one of Embodiments 169 to 174, wherein the bulk density is at least 0.55 g/cm³.

Embodiment 179. The method of any one of Embodiments 1 to 9 or 11 to 178, wherein, prior to said treating, the fermented structure has a void fraction within a range of 5-40%

Embodiment 180. The method of Embodiment 10 or Embodiment 179, wherein the void fraction is within a range of 8-35%.

Embodiment 181. The method of Embodiment 180, wherein the void fraction is within a range of 10-30%.

Embodiment 182. The method of Embodiment 180, wherein the void fraction is within a range of 14-26%.

Embodiment 183. The method of any one of Embodiments 1 to 10 or 12 to 132, wherein, prior to the subjecting, the bundle of protein strands has a water activity of at least 0.6.

Embodiment 184. The method of Embodiment 11 or Embodiment 183, wherein the water activity of the bundle of strands is at least 0.65.

Embodiment 185. The method of Embodiment 184, wherein the water activity of the bundle of strands is at least 0.7.

Embodiment 186. The method of Embodiment 184, wherein the water activity of the bundle of strands is at least 0.75.

Embodiment 187. The method of any one of the preceding Embodiments, wherein the fermented structure includes a matrix formed by the deactivated fermenting microorganism or residue thereof and the protein strands absorbs the liquid, such that following the adding of the liquid, a water content of the fermented protein-based food item is in the range of 50 to 85%, by weight.

Embodiment 188. The method of Embodiment 187, wherein the water content of the fermented protein-based food item is in the range of 55 to 85%, by weight.

Embodiment 189. The method of Embodiment 188, wherein the water content of the fermented protein-based food item is in the range of 60 to 85%, by weight.

Embodiment 190. The method of Embodiment 188, wherein the water content of the fermented protein-based food item is in the range of 60 to 80%, by weight.

Embodiment 191. The method of Embodiment 188, wherein the water content of the fermented protein-based food item is in the range of 60 to 75%, by weight.

Embodiment 192. The method of any one of the preceding Embodiments, wherein the liquid includes an aqueous liquid.

Embodiment 193. The method of Embodiment 192, wherein the aqueous liquid has a weight within a range of 15 to 50%, by weight of the fermented product, prior to the adding of the liquid.

Embodiment 194. The method of Embodiment 192, wherein the aqueous liquid has a weight within a range of 20 to 45%, by weight of the fermented product, prior to the adding of the liquid.

Embodiment 195. The method of Embodiment 192, wherein the aqueous liquid has a weight within a range of 25 to 40%, by weight of the fermented product, prior to the adding of the liquid.

Embodiment 196. The method of any one of the preceding Embodiments, wherein the liquid comprises a liquid containing fat.

Embodiment 197. The method of Embodiment 196, wherein the liquid containing the fat has a weight within a first weight range of 1 to 20%, by weight of the fermented product, prior to the adding of the liquid.

Embodiment 198. The method of Embodiment 197, wherein the first weight range is 1 to 15%.

Embodiment 199. The method of Embodiment 197, wherein the first weight range is 1 to 12%.

Embodiment 200. The method of Embodiment 197, wherein the first weight range is 1 to 8%.

Embodiment 201. The method of Embodiment 197, wherein the first weight range is 2 to 8%.

Embodiment 202. The method of Embodiment 197, wherein the first weight range is 3 to 8%.

Embodiment 203. The method of Embodiment 197, wherein the first weight range is 3 to 6%.

Embodiment 204. The method of Embodiment 197, wherein the first weight range is 3 to 5%.

Embodiment 205. The method of any one of the preceding Embodiments, wherein the liquid containing the fat comprises a hydrophobic liquid.

Embodiment 206. The method of any one of the preceding Embodiments, wherein the liquid containing the fat comprises a lipophilic liquid.

Embodiment 207. The method of any one of the preceding Embodiments, wherein the liquid containing the fat comprises at least 30% fat, by weight.

Embodiment 208. The method of Embodiment 207, wherein the liquid containing the fat comprises at least 50% fat, by weight.

Embodiment 209. The method of Embodiment 207, wherein the liquid containing the fat comprises at least 75% fat, by weight.

Embodiment 210. The method of Embodiment 207, wherein the liquid containing the fat comprises at least 90% fat, by weight.

Embodiment 211. The method of any one of Embodiments 207 to 210, wherein the liquid containing the fat comprises at most 95% fat, by weight.

Embodiment 212. The method of any one of the preceding Embodiments, wherein the added liquid includes a coloring agent.

Embodiment 213. The method of any one of the preceding Embodiments, wherein the cutting comprises slicing the fermented structure or the fermented protein-based food item into slices.

Embodiment 214. The method of Embodiment 213, wherein the slicing is performed whereby a slice of the fermented plant-protein based food item has a thickness in the range of 1 mm to 50 mm.

Embodiment 215. The method of Embodiment 213, wherein the slicing is performed whereby a slice of the fermented plant-protein based food item has a thickness in the range of 1 mm to 40 mm.

Embodiment 216. The method of Embodiment 213, wherein the slicing is performed whereby a slice of the fermented plant-protein based food item has a thickness in the range of 1 mm to 30 mm.

Embodiment 217. The method of Embodiment 213, wherein the slicing is performed whereby a slice of the fermented plant-protein based food item has a thickness in the range of 1 mm to 25 mm.

Embodiment 218. The method of Embodiment 213, wherein the slicing is performed whereby a slice of the fermented plant-protein based food item has a thickness in the range of 2 mm to 25 mm.

Embodiment 219. The method of Embodiment 213, wherein the slicing is performed whereby a slice of the fermented plant-protein based food item has a thickness in the range of 3 mm to 25 mm.

Embodiment 220. The method of any one of Embodiment 213 to 219, wherein the slicing is performed whereby a slice of the fermented plant-protein based food item has a width dimension of at least 6 cm.

Embodiment 221. The method of any one of Embodiment 213 to 219, wherein the slicing is performed whereby a slice of the fermented plant-protein based food item has a width dimension of at least 8 cm.

Embodiment 222. The method of any one of Embodiment 213 to 219, wherein the slicing is performed whereby a slice of the fermented plant-protein based food item has a width dimension of at least 10 cm.

Embodiment 223. The method of any one of Embodiment 213 to 219, wherein the slicing is performed whereby a slice of the fermented plant-protein based food item has a width dimension of at least 12 cm.

Embodiment 224. The method of any one of Embodiment 213 to 223, wherein the slicing is performed whereby a slice of the fermented plant-protein based food item has a width dimension of at most 20 cm.

Embodiment 225. The method of any one of Embodiment 213 to 223, wherein the slicing is performed whereby a slice of the fermented plant-protein based food item has a width dimension of at most 15 cm.

Embodiment 226. The method of any one of Embodiments 213 to 225, wherein the slicing is performed whereby a slice of the fermented plant-protein based food item has a height dimension in a range of 4 cm to 10 cm.

Embodiment 227. The method of Embodiment 226, wherein the slicing is performed whereby the height dimension is in a range of 5 cm to 10 cm.

Embodiment 228. The method of Embodiment 226, wherein the slicing is performed whereby the height dimension is in a range of 6 cm to 10 cm.

Embodiment 229. The method of Embodiment 226, wherein the slicing is performed whereby the height dimension is in a range of 6 cm to 8 cm.

Embodiment 230. The method of any one of the preceding Embodiments, wherein the cutting comprises cutting the fermented structure into chunks.

Embodiment 231. The method of Embodiment 230, wherein the cutting is performed such that said chunks have a volume within a range of 1 cm³ to 10 cm³.

Embodiment 232. The method of any one of Embodiments 1 to 229, wherein the cutting comprises shredding the fermented structure.

Embodiment 233. The method of Embodiment 232, wherein the shredding is performed to produce shreds having a length of 1 to 10 cm and a diameter of 1 to 10 mm.

Embodiment 234. The method of any one of Embodiments 1 to 233, wherein the fermenting organism is a mycelium forming organism.

Embodiment 235. The method of any one of Embodiments 1 to 234, wherein the inoculum further includes a dilution agent.

Embodiment 236. The method of Embodiment 235, wherein the dilution agent comprises a powder.

Embodiment 237. The method of Embodiment 235, wherein the dilution agent is in the form of a liquid.

Embodiment 238. The method of any one of Embodiments 1 to 237, wherein the fermenting microorganism comprises at least 0.1% of the inoculum.

Embodiment 239. The method of any one of Embodiments 1 to 237, wherein the fermenting microorganism comprises at least 0.5% of the inoculum.

Embodiment 240. The method of any one of Embodiments 1 to 237, wherein the fermenting microorganism comprises at least 1% of the inoculum.

Embodiment 241. The method of any one of Embodiments 1 to 237, wherein the fermenting microorganism comprises at least 1.5% of the inoculum.

Embodiment 242. The method of any one of Embodiments 1 to 237, wherein the fermenting microorganism comprises at least 2% of the inoculum.

Embodiment 243. The method of any one of Embodiments 1 to 237, wherein the fermenting microorganism comprises at least 3% of the inoculum.

Embodiment 244. The method of any one of Embodiments 1 to 237, wherein the fermenting microorganism comprises at least 5% of the inoculum.

Embodiment 245. The method of any one of Embodiments 1 to 237, wherein the fermenting microorganism comprises at least 10% of the inoculum.

Embodiment 246. The method of any one of the preceding Embodiments, wherein said CFU count is at most 3,000 CFU/cm².

Embodiment 247. The method of Embodiment 246, wherein said CFU count is at most 1,000 CFU/cm².

Embodiment 248. The method of Embodiment 246, wherein said CFU count is at most 700 CFU/cm².

Embodiment 249. The method of Embodiment 246, wherein said CFU count is at most 500 CFU/cm².

Embodiment 250. The method of Embodiment 246, wherein said CFU count is at most 400 CFU/cm².

Embodiment 251. The method of Embodiment 246, wherein said CFU count is at most 300 CFU/cm².

Embodiment 252. The method of any one of Embodiments 246 to 251, wherein said CFU count is at least 20 CFU/cm².

Embodiment 253. The method of Embodiment 252, wherein said CFU count is at least 30 CFU/cm².

Embodiment 254. The method of Embodiment 252, wherein said CFU count is at least 30 CFU/cm².

Embodiment 255. The method of Embodiment 252, wherein said CFU count is at least 50 CFU/cm².

Embodiment 256. The method of Embodiment 252, wherein said CFU count is at least 70 CFU/cm².

Embodiment 257. The method of any one of the preceding Embodiments, wherein said CFU count is at most 60,000 CFU/g.

Embodiment 258. The method of Embodiment 246, wherein said CFU count is at most 40,000 CFU/g.

Embodiment 259. The method of Embodiment 246, wherein said CFU count is at most 30,000 CFU/g.

Embodiment 260. The method of Embodiment 246, wherein said CFU count is at most 20,000 CFU/g.

Embodiment 261. The method of Embodiment 246, wherein said CFU count is at most 15,000 CFU/g.

Embodiment 262. The method of Embodiment 246, wherein said CFU count is at most 10,000 CFU/g.

Embodiment 263. The method of Embodiment 246, wherein said CFU count is at most 8,500 CFU/g.

Embodiment 264. The method of Embodiment 246, wherein said CFU count is at most 7,000 CFU/g.

Embodiment 265. The method of any one of Embodiments 257 to 265, wherein said CFU count is at least 1,200 CFU/g.

Embodiment 266. The method of Embodiment 265, wherein said CFU count is at least 1,600 CFU/g.

Embodiment 267. The method of Embodiment 265, wherein said CFU count is at least 2,200 CFU/g.

Embodiment 268. The method of Embodiment 265, wherein said CFU count is at least 3,000 CFU/g.

Embodiment 269. The method of any one of Embodiments 1 to 268, wherein the fermented protein-based food item comprises a meat analog.

Embodiment 270. The method of any one of Embodiments 1 to Embodiment 268, wherein the fermented protein-based food item comprises a steak analog.

Embodiment 271. A fermented protein-based meat analog, comprising:
protein strands having a dimensionless aspect ratio ASP defined by:

$$ASP = {L}^{2} / Ax$$

wherein:
L is the average length of the long dimension said strands; and
Ax is the average cross-sectional area of the strand dimensions transverse to said long dimension;
   and wherein ASP is at least 35; and
a mycelium of a fermenting microorganism;
   wherein the protein strands are held together or bound together by the mycelium to form the fermented meat analog.

Embodiment 272. A fermented protein-based meat analog, comprising:
protein strands; and
a mycelium of a fermenting microorganism;
   wherein the protein strands are held together by the mycelium to form the fermented meat analog;
   the fermented meat analog being structured whereby, when sufficient tensile force to effect a mechanical failure is applied at opposing ends of the meat analog, a separation of the meat analog into pieces occurs between the protein strands.

Embodiment 273. A fermented protein-based meat analog, comprising:
protein strands, wherein longitudinal axes of at least 75% of the strands are within 30 degrees of the longitudinal axis of the bundle; and
a mycelium of a fermenting microorganism;
   wherein the protein strands are held together or bound together by the mycelium to form the fermented meat analog.

Embodiment 274. A fermented protein-based meat analog, comprising:
protein strands; and
a mycelium of a fermenting microorganism;
   wherein the protein strands are held together or bound together by the mycelium to form the fermented meat analog;
   and wherein the fermented meat analog is a meat slab analog having a minimal dimension of at least 3 cm.

Embodiment 275. A fermented protein-based meat analog, comprising:
protein strands; and
a mycelium of a fermenting microorganism;
   wherein the protein strands and the mycelium form a liquid-absorbing matrix;
   and wherein a water content of the meat analog is in the range of 50 to 85%, by weight.

Embodiment 276. A fermented protein-based meat analog, comprising:
protein strands; and
a mycelium of a fermenting microorganism;
   wherein the protein strands are held together or bound together by the mycelium to form the fermented meat analog;
   and wherein a weight of any binding material within the meat analog is at most 15%, by weight of the fermented protein-based meat analog.

Embodiment 277. A fermented protein-based meat analog, comprising:
protein strands; and
a mycelium of a fermenting microorganism;
   wherein the protein strands are held together or bound together by the mycelium to form the fermented meat analog.

Embodiment 278. The meat analog of any one of Embodiments 271 to 277, wherein the fermenting microorganism is a deactivated fermenting microorganism.

Embodiment 279. The meat analog of any one of Embodiments 271 to 278, further comprising a residue of the fermenting microorganism or the deactivated fermenting microorganism.

Embodiment 280. The meat analog of Embodiment 279, wherein the residue includes spores of the fermenting microorganism or the deactivated fermenting microorganism.

Embodiment 281. The meat analog of any one of Embodiments 278 to 280, wherein at least one of the deactivated fermenting microorganism and the residue includes DNA of the fermenting microorganism or the deactivated fermenting microorganism.

Embodiment 282. The meat analog of any one of Embodiments 278 to 281, wherein at least one of the deactivated fermenting microorganism and the residue includes a component of a cell wall of the fermenting microorganism.

Embodiment 283. The meat analog of Embodiment 282, wherein the component of the cell wall comprises ergosterol.

Embodiment 284. The meat analog of any one of Embodiments 271 to 283, wherein the protein strands contain at least 25% protein, by weight, on a dry basis.

Embodiment 285. The meat analog of Embodiment 284, wherein the protein strands contain at least 30% protein, by weight, on a dry basis.

Embodiment 286. The meat analog of Embodiment 284, wherein the protein strands contain at least 40% protein, by weight, on a dry basis.

Embodiment 287. The meat analog of Embodiment 284, wherein the protein strands contain at least 50% protein, by weight, on a dry basis.

Embodiment 288. The meat analog of any one of Embodiments 271 to 287, wherein the protein strands include plant protein.

Embodiment 289. The meat analog of any one of Embodiments 271 to 287, wherein the protein in the protein strands predominantly includes plant protein.

Embodiment 290. The meat analog of any one of Embodiments 271 to 287, wherein the protein in the protein strands consists essentially of plant protein.

Embodiment 291. The meat analog of any one of Embodiments 271 to 290, wherein the protein strands include soy protein.

Embodiment 292. The meat analog of any one of Embodiments 271 to 291, wherein the protein in the protein strands includes extruded vegetable protein.

Embodiment 293. The meat analog of any one of Embodiments 271 to 291, wherein the protein in the protein strands predominantly includes extruded vegetable protein.

Embodiment 294. The meat analog of any one of Embodiments 271 to 293, wherein the protein in the protein strands includes denatured protein.

Embodiment 295. The meat analog of any one of Embodiments 271 to 293, wherein the protein in the protein strands predominantly includes denatured protein.

Embodiment 296. The meat analog of any one of Embodiments 271 to 295, wherein the protein in the protein strands includes cross-linked protein.

Embodiment 297. The meat analog of any one of Embodiments 271 to 295, wherein the protein in the protein strands predominantly includes cross-linked protein.

Embodiment 298. The meat analog of any one of Embodiments 271 to 297, wherein the protein strands have a maximal dimension, in a cross section of a longitudinal axis thereof, in the range of 0.5 mm to 5 mm.

Embodiment 299. The meat analog of Embodiment 298, wherein the maximal dimension is in the range of 0.5 mm to 4 mm.

Embodiment 300. The meat analog of Embodiment 298, wherein the maximal dimension is in the range of 0.5 mm to 3 mm.

Embodiment 301. The meat analog of Embodiment 298, wherein the maximal dimension is in the range of 0.5 mm to 2 mm.

Embodiment 302. The meat analog of Embodiment 298, wherein the maximal dimension is in the range of 1 mm to 2 mm.

Embodiment 303. The meat analog of any one of Embodiments 271 to 302, wherein an average length of a long dimension of the strands is at least 1 mm.

Embodiment 304. The meat analog of Embodiment 303, wherein the average length is at least 3 mm.

Embodiment 305. The meat analog of Embodiment 303, wherein the average length is at least 4 mm.

Embodiment 306. The meat analog of Embodiment 303, wherein the average length is at least 5 mm.

Embodiment 307. The meat analog of Embodiment 303, wherein the average length is at least 8 mm.

Embodiment 308. The meat analog of Embodiment 303, wherein the average length is at least 10 mm.

Embodiment 309. The meat analog of Embodiment 303, wherein the average length is at least 15 mm.

Embodiment 310. The meat analog of Embodiment 303, wherein the average length is at least 20 mm.

Embodiment 311. The meat analog of Embodiment 303, wherein the average length is at least 50 mm.

Embodiment 312. The meat analog of Embodiment 303, wherein the average length is at least 100 mm.

Embodiment 313. The meat analog of Embodiment 303, wherein the average length is at least 250 mm.

Embodiment 314. The meat analog of Embodiment 303, wherein the average length is at most 700 mm.

Embodiment 314A. The meat analog of Embodiment 303, wherein the average length is at most 600 mm.

Embodiment 315. The meat analog of any one of Embodiments 271 to 314, wherein the protein strands have a dimensionless aspect ratio ASP defined by:

$$ASP = {L}^{2} / Ax$$

wherein:
   L is the average length of the long dimension said strands; and
   Ax is the average cross-sectional area of the strand dimensions transverse to said long dimension;
   and wherein ASP is at least 40.

Embodiment 316. The meat analog of Embodiment 315, wherein ASP is at least 50.

Embodiment 317. The meat analog of Embodiment 315, wherein ASP is at least 60.

Embodiment 318. The meat analog of Embodiment 315, wherein ASP is at least 80.

Embodiment 319. The meat analog of Embodiment 315, wherein ASP is at least 100.

Embodiment 320. The meat analog of Embodiment 315, wherein ASP is at least 200.

Embodiment 321. The meat analog of Embodiment 315, wherein ASP is at least 300.

Embodiment 321A. The meat analog of any one of Embodiments 315 to 321, wherein ASP is at most 600.

Embodiment Embodiment 321B. The meat analog of Embodiment 321A, wherein ASP is at most 400.

Embodiment 321C. The meat analog of any one of Embodiments 315 to 321B, wherein the meat analog is a slice of a meat analog slab.

Embodiment 321D. The meat analog of Embodiment 321C, wherein the slice is a steak.

Embodiment 322. The meat analog of Embodiment 315, wherein the meat analog is a meat slab, and wherein ASP is at least 1,000.

Embodiment 323. The meat slab of Embodiment 322, wherein ASP is at least 1,500.

Embodiment 323A. The meat slab of Embodiment 322, wherein ASP is at least 2,000.

Embodiment 323B. The meat slab of Embodiment 322, wherein ASP is at least 2,500.

Embodiment 323C. The meat slab of Embodiment 322, wherein ASP is at least 3,000.

Embodiment 323D. The meat slab of Embodiment 322, wherein ASP is at least 4,000.

Embodiment 323E. The meat slab of Embodiment 322, wherein ASP is at least 5,000.

Embodiment 323F. The meat slab of Embodiment 322, wherein ASP is at least 6,000.

Embodiment 323G. The meat slab of Embodiment 322, wherein ASP is at least 8,000.

Embodiment 323H. The meat analog of any one of Embodiments 315 to 321 and 322 to 323G, wherein ASP is at most 100,000.

Embodiment 324. The meat analog of Embodiment 323H, wherein ASP is at most 50,000.

Embodiment 325. The meat analog of Embodiment 323H, wherein ASP is at most 20,000.

Embodiment 326. The meat analog of any one of Embodiments 315 to 325, wherein Ax is within a range of 0.26 mm² to 25 mm².

Embodiment 327. The meat analog of Embodiment 326, wherein Ax is within a range of 1 mm² to 25 mm².

Embodiment 328. The meat analog of any one of Embodiments 315 to 327, wherein L is at least 5 mm.

Embodiment 329. The meat analog of Embodiment 328, wherein L is at least 6 mm.

Embodiment 330. The meat analog of Embodiment 328, wherein L is at least 8 mm.

Embodiment 331. The meat analog of Embodiment 328, wherein L is at least 10 mm.

Embodiment 332. The meat analog of Embodiment 328, wherein L is at least 15 mm.

Embodiment 333. The meat analog of Embodiment 328, wherein L is at least 20 mm.

Embodiment 334. The meat analog of Embodiment 328, wherein L is at least 50 mm.

Embodiment 335. The meat analog of Embodiment 328, wherein L is at least 100 mm.

Embodiment 336. The meat analog of Embodiment 328, wherein L is at least 250 mm.

Embodiment 337. The meat analog of Embodiment 328, wherein L is at most 500 mm.

Embodiment 338. The meat analog of Embodiment 271 or any one of Embodiments 273 to 337, the fermented meat analog being structured whereby, when sufficient tensile force to effect a mechanical failure is applied at opposing ends of the meat analog, a separation of the meat analog into pieces occurs between the protein strands.

Embodiment 339. The meat analog of Embodiment 338, wherein the cohesive strength within the protein strands exceeds the cohesive strength of the portion of the meat analog disposed outside of the protein strands.

Embodiment 340. The meat analog of any one of Embodiments 271 to 339, wherein longitudinal axes of at least 80% of the protein strands are within 30 degrees of the longitudinal axis of the bundle.

Embodiment 341. The meat analog of Embodiment 340, wherein longitudinal axes of at least 85% of the strands are within 30 degrees of the longitudinal axis of the bundle.

Embodiment 342. The meat analog of Embodiment 340, wherein longitudinal axes of at least 90% of the strands are within 30 degrees of the longitudinal axis of the bundle.

Embodiment 343. The meat analog of Embodiment 340, wherein longitudinal axes of at least 95% of the strands are within 30 degrees of the longitudinal axis of the bundle.

Embodiment 344. The meat analog of any one of Embodiments 340 to 343, wherein longitudinal axes of at least 80% of the strands are within 25 degrees of the longitudinal axis of the bundle.

Embodiment 345. The meat analog of Embodiment 344, wherein longitudinal axes of at least 80% of the strands are within 20 degrees of the longitudinal axis of the bundle.

Embodiment 346. The meat analog of Embodiment 344, wherein longitudinal axes of at least 80% of the strands are within 15 degrees of the longitudinal axis of the bundle.

Embodiment 347. The meat analog of Embodiment 344, wherein longitudinal axes of at least 80% of the strands are within 10 degrees of the longitudinal axis of the bundle.

Embodiment 348. The meat analog of Embodiment 344, wherein longitudinal axes of at least 80% of the strands are within 5 degrees of the longitudinal axis of the bundle.

Embodiment 349. The meat analog of any one of Embodiments 271 to 273 or Embodiments 275 to 348, wherein the fermented meat analog is a meat slab analog having a minimal dimension of at least 3 cm.

Embodiment 350. The meat analog of Embodiment 349, wherein the minimal dimension is at least 3.2 cm.

Embodiment 351. The meat analog of Embodiment 349, wherein the minimal dimension is at least 3.5 cm.

Embodiment 352. The meat analog of Embodiment 349, wherein the minimal dimension is at least 3.8 cm.

Embodiment 353. The meat analog of Embodiment 349, wherein the minimal dimension is at least 4 cm.

Embodiment 354. The meat analog of Embodiment 349, wherein the minimal dimension is at least 4.5 cm.

Embodiment 355. The meat analog of Embodiment 349, wherein the minimal dimension is at least 5 cm.

Embodiment 356. The meat analog of Embodiment 274 or any one of Embodiments 349 to 355, wherein the minimal dimension is at most 20 cm.

Embodiment 357. The meat analog of Embodiment 356, wherein the minimal dimension is at most 17 cm.

Embodiment 358. The meat analog of Embodiment 356, wherein the minimal dimension is at most 14 cm.

Embodiment 359. The meat analog of Embodiment 356, wherein the minimal dimension is at most 12 cm.

Embodiment 360. The meat analog of Embodiment 356, wherein the minimal dimension is at most 10 cm.

Embodiment 361. The meat analog of Embodiment 274 or any one of Embodiments 349 to 360, dimensioned to be sliced into at least two slices, each slice having a thickness within the range of 1 mm to 50 mm.

Embodiment 362. The meat analog of Embodiment 361, dimensioned such that the thickness of each slice is in the range of 1 mm to 40 mm.

Embodiment 363. The meat analog of Embodiment 361, dimensioned such that the thickness of each slice is in the range of 1 mm to 30 mm.

Embodiment 364. The meat analog of Embodiment 361, dimensioned such that the thickness of each slice is in the range of 1 mm to 25 mm.

Embodiment 365. The meat analog of Embodiment 361, dimensioned such that the thickness of each slice is in the range of 2 mm to 25 mm.

Embodiment 366. The meat analog of Embodiment 361, dimensioned such that the thickness of each slice is in the range of 3 mm to 25 mm.

Embodiment 367. The meat analog of any one of Embodiments 361 to 366, dimensioned such that each slice has a width dimension of at least 6 cm.

Embodiment 368. The meat analog of any one of Embodiments 361 to 366, dimensioned such that each slice has a width dimension of at least 8 cm.

Embodiment 369. The meat analog of any one of Embodiments 361 to 366, dimensioned such that each slice has a width dimension of at least 10 cm.

Embodiment 370. The meat analog of any one of Embodiments 361 to 366, dimensioned such that each slice has a width dimension of at least 12 cm.

Embodiment 371. The meat analog of any one of Embodiments 361 to 370, dimensioned such that each slice has a width dimension of at most 30 cm.

Embodiment 372. The meat analog of Embodiment 371, dimensioned such that each slice has a width dimension of at most 20 cm.

Embodiment 373. The meat analog of any one of Embodiments 361 to 372, dimensioned such that each slice has a height dimension in the range of 4 cm to 10 cm.

Embodiment 374. The meat analog of any one of Embodiments 361 to 372, dimensioned such that each slice has a height dimension in the range of 5 cm to 10 cm.

Embodiment 375. The meat analog of any one of Embodiments 361 to 372, dimensioned such that each slice has a height dimension in the range of 6 cm to 10 cm.

Embodiment 376. The meat analog of any one of Embodiments 361 to 372, dimensioned such that each slice has a height dimension in the range of 6 cm to 8 cm.

Embodiment 377. The meat analog of any one of the preceding Embodiments, wherein a matrix formed by the protein strands and mycelium of the fermenting microorganism absorbs liquid therein, and wherein a total liquid content of the meat analog is in the range of 50 to 85%, by weight.

Embodiment 378. The meat analog of Embodiment 377, wherein the total liquid content is in the range of 55 to 85%, by weight.

Embodiment 379. The meat analog of Embodiment 377, wherein the total liquid content is in the range of 60 to 85%, by weight.

Embodiment 380. The meat analog of Embodiment 377, wherein the total liquid content is in the range of 60 to 80%, by weight.

Embodiment 381. The meat analog of Embodiment 377, wherein the total liquid content is in the range of 60 to 75%, by weight.

Embodiment 382. The meat analog of any one of the preceding Embodiments, wherein a weight fraction of any binding material binding the strands, excluding the mycelium, is at most 15%, by weight of the meat analog.

Embodiment 383. The meat analog of Embodiment 382, wherein the weight fraction of the binding material is at most 12%, by weight of the meat analog.

Embodiment 384. The meat analog of Embodiment 382, wherein the weight fraction of the binding material is at most 7%, by weight of the meat analog.

Embodiment 385. The meat analog of Embodiment 382, wherein the weight fraction of the binding material is at most 2%, by weight of the meat analog.

Embodiment 386. The meat analog of any one of the preceding Embodiments, wherein the meat analog is devoid of any layer of binding material.

Embodiment 386A. The meat analog of any one of the preceding Embodiments, wherein the meat analog is devoid of any layer of binding material, aside from any mycelium layer.

Embodiment 387. The meat analog of any one of Embodiments 271 to 386A, wherein the weight fraction of any hydrocolloids in the meat analog is at most 0.7%.

Embodiment 388. The meat analog of any one of Embodiments 271 to 386A, wherein the weight fraction of any hydrocolloids in the meat analog is at most 0.3%.

Embodiment 389. The meat analog of any one of Embodiments 271 to 386A, wherein the weight fraction of any hydrocolloids in the meat analog is at most 0.1%.

Embodiment 390. The meat analog of any one of Embodiments 271 to 389, wherein the weight fraction of any hydrocolloids disposed within the meat analog, but outside of the protein strands and the mycelium, is at most 0.5%.

Embodiment 391. The meat analog of any one of Embodiments 271 to 389, wherein the weight fraction of any hydrocolloids disposed within the meat analog, but outside of the protein strands and the mycelium, is at most 0.2%.

Embodiment 392. The meat analog of any one of Embodiments 271 to 389, wherein the weight fraction of any hydrocolloids disposed within the meat analog, but outside of the protein strands and the mycelium, is at most 0.1%.

Embodiment 393. The meat analog of any one of Embodiments 271 to 392, wherein the mycelium adheres to the protein strands to form the meat analog.

Embodiment 394. The meat analog of any one of Embodiments 271 to 393, wherein the mycelium penetrates the protein strands to bind the protein strands, thereby to form the meat analog.

Embodiment 395. The meat analog of any one of Embodiments 271 to 394, wherein the mycelium mechanically binds to the protein strands to form the meat analog.

Embodiment 396. The meat analog of any one of Embodiments 271 to 395, wherein the mycelium chemically binds to the protein strands to form the meat analog.

Embodiment 397. The meat analog of any one of Embodiments 271 to 396, wherein the weight fraction of any liquid bound by a hydrocolloid is at most 10%.

Embodiment 398. The meat analog of Embodiment 397, wherein the weight fraction of the liquid bound by the hydrocolloid is at most 5%.

Embodiment 399. The meat analog of Embodiment 397, wherein the weight fraction of the liquid bound by the hydrocolloid is at most 2%.

Embodiment 400. The meat analog of Embodiment 397, wherein the weight fraction of the liquid bound by the hydrocolloid is at most 1%.

Embodiment 401. The meat analog of any one of Embodiments 271 to 400, wherein the water content of the meat analog is within a range of 50 to 80%, by weight.

Embodiment 402. The meat analog of Embodiment 401, wherein the water content is at least 52%.

Embodiment 403. The meat analog of Embodiment 401, wherein the water content is at least 55%.

Embodiment 404. The meat analog of Embodiment 401, wherein the water content is at least 60%.

As used herein in the specification and in the claims section that follows, the term “water activity” of a food, or a raw material thereof (e.g., a bundle of strands) refers to the ratio between the vapor pressure of the food itself, when in a completely undisturbed balance (equilibrium) with the surrounding air media, and the vapor pressure of distilled water under identical conditions (including temperature and pressure).

As used herein in the specification and in the claims section that follows, the term “mycelium” is used generally as used in the art. For the avoidance of doubt, “mycelium” refers to living and non-living (“deactivated”) structures or forms.

The mycelium contains, or consists essentially of hyphae, each hypha having a long, branching, filamentous structure.

As used herein in the specification and in the claims section that follows, the term “average length”, typically with reference to a plurality of strands or a bundle of strands, refers to the arithmetic mean of the length of each individual strand within the respective plurality of strands or bundle of strands, i.e., the sum of the length of each individual strand (ΣLᵢ) divided by the number of individual strands (N).

While the length of each individual strand along its longitudinal axis may vary slightly (the end face may not be perpendicular to the longitudinal axis), the length may be taken as the maximal length of the strand along its longitudinal axis.

As used herein in the specification and in the claims section that follows, the term “longitudinal axis”, with reference to a strand, refers to the axis representing the longest dimension (length) of the strand.

As used herein in the specification and in the claims section that follows, the term “longitudinal axis”, with reference to a plurality of strands or a bundle of strands, refers to an imaginary axis generally disposed in the longitudinal direction of the strands, the exact direction of which is determined by setting to zero the sum of each strand's deviation from the imaginary axis.

As used herein in the specification and in the claims section that follows, the term “length”, with reference to a meat analog slab, meat analog slice, steak (cut) analog, and the like, refers to the dimension in the general direction of the fibers within the slab, slice or cut.

As used herein in the specification and in the claims section that follows, the terms “width” and “height”, with reference to a meat analog slab, meat analog slice, steak analog, and the like, refers to the two remaining Cartesian dimensions after “length” has been determined, with “width” being assigned to the larger of the two remaining dimensions and “height” being assigned to the smaller of the two remaining dimensions.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method of manufacturing a fermented protein-based food item, the method comprising:
a. obtaining protein strands of a low-moisture extruded vegetable protein containing at least 25% protein, by weight, on a dry basis, wherein said protein strands have a dimensionless aspect ratio ASP defined by:
$$ASP = {L}^{2} / Ax$$
wherein:
L is the average length of the long dimension said protein strands; and
Ax is the average cross-sectional area of the strand dimensions transverse to said long dimension;
and wherein ASP is at least 100;
b. inoculating the protein strands with an inoculum including a fermenting microorganism;
c. bundling the protein strands to produce a bundle of strands, the bundle of strands having a bulk density within a range of 0.35 to 0.85 g/cm³;
d. following steps b and c, enveloping the bundle of strands in a fermentation housing;
e. subjecting the inoculated bundle of strands to fermentation to produce a fermented structure, wherein, at the time of the subjecting to fermentation, the colony forming unit (CFU) count of the fermenting microorganism in the inoculum on at least one of the protein strands, with respect to the cumulative surface area of the at least one of the protein strands, is 50-3000 CFU/cm²; and
f. treating the fermented structure to produce the fermented protein-based food item.

2. The method of claim 1, wherein said bulk density is at most 0.8 g/cm³.

3. The method of claim 2, wherein said bulk density is at most 0.75 g/cm³.

4. The method of claim 3, wherein said bulk density is at most 0.7 g/cm³.

5. The method of claim 4, wherein said bulk density is at most 0.65 g/cm³.

6. The method of claim 3, wherein said fermented structure has a void fraction within a range of 10-30%.

7. The method of claim 6, wherein said void fraction is within a range of 14-26%.

8. The method of claim 7, wherein said CFU count is at most 1,000 CFU/cm².

9. The method of claim 8, wherein said CFU count is at least 70 CFU/cm².

10. The method of claim 7, wherein ASP is at least 250.

11. The method of claim 10, wherein ASP is at least 500.

12. The method of claim 10, wherein ASP is at least 750.

13. The method of claim 10, wherein ASP is at least 1000.

14. The method of claim 10, wherein ASP is at least 1500.

15. The method of claim 10, wherein ASP is at most 1,000,000.

16. The method of claim 6, wherein the inoculating is performed layer-by-layer, prior to the bundling.

17. The method of claim 16, wherein the inoculating of each layer comprises scattering the inoculum over one side of the layer.

18. The method of claim 6, wherein, prior to the bundling, the inoculum covers 0.1% to 50% of the surface area of the protein strands.

19. The method of claim 6, wherein the treating includes deactivating the fermenting microorganism.

20. The method of claim 6, wherein the treating includes adding liquid to the fermented structure.
